(19) United States
(12) Patent Application Publication
(10) Pub. No.: US 2025/0345644 A1
(43) Pub. Date: Nov. 13, 2025

(54) FIRE RETARDANT COMPOSITIONS CONTAINING A CARBONATE SALT AND ONE OR MORE CORROSION INHIBITORS

(71) Applicant: PERIMETER SOLUTIONS LP, Clayton, MO (US)

(72) Inventors: Jinxue JIANG, Rancho Cucamonga, CA (US); Marcela MUNOZ, Fontana, CA (US); Melissa KIM, Ontario, CA (US)

(21) Appl. No.: 19/201,082

(22) Filed: May 7, 2025

Related U.S. Application Data
(60) Provisional application No. 63/644,317, filed on May 8, 2024.
(60) Provisional application No. 63/750,407, filed on Jan. 28, 2025.

(51) Int. Cl. A62D 1/00

(52) U.S. Cl. CPC A62D 1/0035

(57) ABSTRACT

The present invention relates to fire retardant compositions containing at least one carbonate salt, including long-term fire retardant compositions containing at least one carbonate salt and one or more corrosion inhibitors. The fire retardant compositions may be fire retardant concentrate compositions and fire retardant solutions. Compositions of the present invention include solid (e.g., dry) and liquid fire retardant concentrates. Solid fire retardant concentrate compositions include powder fire retardant concentrates (e.g., flowable powder concentrates). Suitable corrosion inhibitors include carboxylic acids (and salts thereof), fatty acids (and salts thereof), water soluble divalent cation compounds, alkali metal phosphates, one or more organic absorption components, and one or more corrosion inhibitor-surfactants. In various embodiments, the fire retardant composition includes one or more of such corrosion inhibitors. Further in accordance with the present invention, the compositions described herein include one or more pH adjustor compounds along with a corrosion inhibitor(s).

### REFERENCE TO RELATED APPLICATIONS

This application claims the benefit of and priority to U.S. Provisional Patent Application Ser. No. 63/644,317, filed May 8, 2024, and U.S. Provisional Patent Application Ser. No. 63/750,407, filed Jan. 28, 2025, the entire contents of which are hereby incorporated by reference for all relevant purposes.

### FIELD OF THE INVENTION

The present invention relates to fire retardant compositions containing at least one carbonate salt, including long-term fire retardant compositions containing at least one carbonate salt and one or more corrosion inhibitors. The fire retardant compositions may be fire retardant concentrate compositions and fire retardant solutions. Compositions of the present invention include solid (e.g., dry) and liquid fire retardant concentrates. Solid fire retardant concentrate compositions include powder fire retardant concentrates (e.g., flowable powder concentrates). Suitable corrosion inhibitors include carboxylic acids (and salts thereof), fatty acids (and salts thereof), water soluble divalent cation compounds, alkali metal phosphates, one or more organic absorption components, and one or more corrosion inhibitor-surfactants. In various embodiments, the fire retardant composition includes one or more of such corrosion inhibitors. Further in accordance with the present invention, the compositions described herein include one or more pH adjustor compounds along with a corrosion inhibitor(s).

### BACKGROUND OF THE INVENTION

Often, large-scale wildfires occur in areas such as western regions of the United States, including densely populated areas, and may cause significant damage to both individuals and property. Such fires and damage may occur on an annual basis. The use of fire retardant chemicals has been known to be an effective way to prevent and combat wildfires for decades. Generally, fire retardant compositions are known to be effective for decreasing the flammability and/or combustibility of materials, including wildland vegetation such as forest and grassy materials, and for increasing the resistance of these materials to heat and flame damage. The United States Forest Service (USFS) has established standards for firefighting compositions including those containing fire retardants (e.g., long-term fire retardants), foam fire suppressants, and water enhancers. It is to be understood that use of the term “fire retardant” herein without the designation “long-term” does not indicate the retardant is not a long-term fire retardant as understood generally or in accordance with USFS standards.

In particular, the USFS has established that retardants, including long-term retardants should contain retardant chemicals that alter the way the fire burns, decrease the fire intensity, and/or slow the advance of the fire, even after the water they originally contained has evaporated. Different fire retardant chemicals have different properties, responses and/or reaction mechanisms in the presence of a heat or fire source. Accordingly, various fire retardant compositions have been explored to combat fire damage, including that from wildland vegetation.

Over the past decades, retardants, in particular long-term retardants have been focused on those chemicals which can convert the wildland vegetation from a substance that is flammable and, consequently, a fuel, to a chemically modified or converted substance with difficulty of igniting and providing fuel source when subjected to heat and beyond its ignition point for starting a fire. Ammonium phosphate based long-term retardants belong to this category, which perform under a condensed-phase fire retardant mechanism having a char formation model. This type of retardant undergoes thermal degradation at elevated temperature to generate pyrophosphoric acids, which can catalyze dehydration of carbohydrate materials to form an insulating char layer on the surface of the potential fuel source and reduce the release of volatile combustible gases.

Fire retardant concentrate compositions comprising mixtures of monoammonium phosphate, diammonium phosphate and/or ammonium polyphosphate for combating wildfire either directly onto flaming fuel or indirectly onto the fuel ahead of a potentially advancing fire front are known. Fire retardant compositions comprising ammonium phosphate mixtures as effective wildfire retardants with decreased corrosion to metals and decreased aquatic toxicity are also known. As indicated, various fire retardant compositions for combating wildfire are based on phosphate chemicals and have a fire retardant mechanism based on condensed-phase char formation. Such phosphate based compounds have been proven effective as fire retardant chemicals, making them useful in wildfire retardant formulations. However, additional options of retardant chemicals may be desired in certain circumstances.

Carbonate compounds are currently believed to be promising candidates as retardants for combatting wildfires through thermal quenching and/or gas-phase dilution mechanisms. Carbonates will undergo thermal degradation by absorbing heat from surrounding environments at elevated temperatures. The thermal quenching process will lead to lowering the temperature of the fuel substrate to below its ignition point. Additionally, or alternatively, thermal degradation of carbonate compounds will result in release of non-flammable gases such as carbon dioxide and water vapor. The inert gas emission serves to dilute the concentration of the surrounding oxygen, resulting in self-extinguishment of fuel substrates. As described in the present disclosure, one area of investigation for alternative fire retardant compounds is carbonate compounds. Such alternative fire retardants are currently believed to be provided by the fire retardant compositions disclosed herein. Further, advances in the use of carbonate compounds in terms of metal corrosion are being investigated. Accordingly, further investigations involve new and/or more effective corrosion inhibitors for use in fire retardant compositions including one or more carbonate compounds.

### BRIEF SUMMARY OF THE INVENTION

Briefly, therefore, the present invention is directed to fire retardant compositions comprising: (i) at least one fire retardant comprising at least one carbonate salt, wherein the at least one carbonate salt is selected from the group consisting of metal salts (e.g., alkali metal salts), ammonium salts, guanidine salts, and combinations thereof (e.g., wherein the at least one fire retardant is present in the composition at a concentration of from about 5 wt % to about 100 wt % of the composition or from about 10 wt % to about 100 wt % of the composition); (ii) a corrosion inhibitor for at least one of steel, aluminum, brass and/or magnesium selected from those described therein and combinations thereof; and (iii) a pH adjustor compound for the purpose of regulating the pH of the composition within a range of from about 4 to about 10.

The present is further directed to fire retardant solutions prepared from any of the compositions (e.g., concentrates) of the present invention.

Other objects and features will be in part apparent and in part pointed out hereinafter.

### DETAILED DESCRIPTION OF THE INVENTION

The present disclosure generally relates to firefighting compositions (e.g., retardants) including one or more carbonate salts as the fire retardant along with various other components. Without being bound to any particular theory, it is currently believed that when exposed to elevated temperatures carbonate salts will experience thermal degradation resulting in the release of non-flammable gases (e.g., carbon dioxide (CO₂) and water vapor (H₂O(g)). These non-flammable gases emitted serve to dilute the concentration of the surrounding oxygen, resulting in fire retardancy and/or self-extinguishment of fuel substrates.

### Fire Retardant

Generally, the present compositions contain at least one fire retardant component comprising at least one carbonate salt. The carbonate salt(s) is typically selected from the group consisting of metal salts, ammonium salts, guanidine salts, and combinations thereof. Generally, the at least one fire retardant is present in the composition at a concentration of from about 5 wt % to about 100 wt %, from about 10 wt % to about 100 wt % by weight of the composition, from about 10 wt % to about 90 wt % of the composition, from about 10 wt % to about 80 wt % of the composition, from about 10 wt % to about 70 wt % of the composition, from about 10 wt % to about 60 wt % of the composition, from about 10 wt % to about 50 wt % of the composition, from about 10 wt % to about 40 wt % of the composition, from about 10 wt % to about 30 wt % of the composition, from about 10 wt % to about 20 wt % of the composition, or from about 10 wt % to about 15 wt % of the composition.

In various embodiments, the metal salt is an alkali metal salt (e.g., sodium, potassium, lithium, calcium, or magnesium, typically sodium or potassium). In certain embodiments, the carbonate salt comprises an alkali metal carbonate salt selected from the group consisting of potassium carbonate, potassium bicarbonate, sodium carbonate, sodium bicarbonate, lithium carbonate, and combinations thereof.

In these and certain other embodiments the one or more carbonate salts are selected from the group consisting of potassium carbonate, potassium bicarbonate, and combinations thereof.

In these and further embodiments, the at least one carbonate salt comprises an alkali metal carbonate salt selected from the group consisting of sodium carbonate, sodium bicarbonate, and combinations thereof.

In these and still further embodiments, the at least one carbonate salt comprises an ammonium carbonate salt selected from ammonium carbonate, ammonium bicarbonate, and combinations thereof.

Other suitable carbonate salts include magnesium carbonate, magnesium bicarbonate, calcium carbonate, calcium bicarbonate, and combinations thereof.

In still further embodiments, the at least one carbonate salt comprises guanidine carbonate.

In certain embodiments, the at least one fire retardant comprises a carbonate selected from the group consisting of potassium carbonate, potassium bicarbonate, sodium carbonate, sodium bicarbonate, ammonium carbonate, ammonium bicarbonate, guanidine carbonate, and combinations thereof.

### Additional Fire Retardants

In addition to the above, compositions of the present invention may further include an ammonium phosphate-based fire retardant selected from the group consisting of monoammonium phosphate (MAP), diammonium phosphate (DAP), ammonium polyphosphate (APP), and combinations thereof.

The compositions of the present invention may further include a nitrogen containing fire retardant (e.g., urea, dicyandiamide and melamine), magnesium chloride fire retardant (e.g., magnesium chloride hexahydrate (MgCl₂·H₂Oₓ, anhydrous magnesium chloride), and/or magnesium sulfate as a fire retardant. Without being bound to any particular theory, it is currently believed the nitrogen-containing compound also acts as a fire retardant through a gas dilution mechanism like the carbonate compounds. Thus, the nitrogen-containing compound may provide enhanced performance when combined with the carbonate fire retardant. However, it is to be understood that the presence of a nitrogen-containing compound is not required for a carbonate fire retardant to provide enhanced or even acceptable performance. As detailed above and elsewhere herein, the carbonate-based fire retardants have been observed as suitable stand-alone fire retardants.

Suitable magnesium chloride fire retardants include MgCl₂ and magnesium chloride hydrates (i.e., MgCl₂·(H₂O)ₓ, where x is 1, 2, 4, 6, 8, or 12). In various embodiments, the magnesium chloride fire retardant is magnesium chloride hexahydrate (i.e., MgCl₂·6(H₂O)).

Suitable magnesium sulfate fire retardants include MgSO₄ and magnesium sulfate hydrates (i.e., MgSO₄·(H₂O)ₓ, where x is 1, 2, 3, 4, 5, 6, 7, 9, 10 or 11).

Typically, any additional fire retardant(s) is present at a concentration of at least about 1 wt %, at least about 2 wt %, or at least about 3 wt %, and up to about 4 wt %, up to about 5 wt %, or up to about 10 wt % as the upper limit.

### Fire Retardant Concentrates

Various aspects of the present invention involve fire retardant concentrates.

In certain aspects, the composition is in the form of a solid concentrate (e.g., dry concentrate, a powder concentrate, or a flowable powder concentrate).

Typically, in accordance with such embodiments, the at least one fire retardant is present in a concentration of at least about 75 wt %, at least about 80 wt %, at least about 85 wt %, at least about 90 wt %, at least about 95 wt %, or above any of these lower limits and up to about 95 wt %.

Aspects of the present invention are also directed to liquid fire retardant concentrates.

Typically, in accordance with such embodiments, the at least one fire retardant is present in a concentration of less than about 95 wt %, less than about 85 wt %, less than about 80 wt %, less than about 75 wt %, less than about 70 wt %, less than about 65 wt %, less than about 60 wt %, less than about 55 wt %, less than about 50 wt %, less than about 45 wt %, or less than about 40 wt %, or below any of these upper limits and above at least about 25 wt %. Additionally, or alternatively, water is typically present in a concentration of at least about 20 wt %, at least about 25 wt %, at least about 30 wt %, at least about 35 wt %, at least about 40 wt %, at least about 45 wt %, at least about 50 wt %, or above any of these lower limits and below at least about 60 wt %.

Further in accordance with the foregoing, the compositions of the present disclosure include one or more of the following components in the following concentrations, proportions, etc. and in accordance with the compositions defined in the appended claims.

Fire retardant concentrates of the present invention may be in the form of solid (dry, e.g., powder) concentrates or may be liquid concentrates. Additionally, or alternatively, liquid concentrates may be prepared from solid concentrates by dilution with water. In this regard, it is to be understood that such liquid concentrates have not been diluted to such a level that would provide a fire retardant solution as discussed herein. Liquid concentrates may also be prepared by diluting the fire retardant(s) and other components included in the concentrate as described herein with water.

### Solid (Dry) Concentrates

Solid (e.g., dry and/or powder) concentrate compositions of the present invention typically further comprise one or more thickeners. Representative thickeners include xanthan gum, rhamsan gum, velan gum, diutan gum, guar gum, and mixtures thereof. In certain embodiments, the thickener is xanthan gum.

The thickener is typically present in a proportion of at least about 1 wt %, at least about 1.5 wt %, at least about 1.75 wt %, at least about 2 wt %, or at least about 2.5 wt %. Often, the thickener is present in a proportion of from about 1 wt % to about 8 wt %, 1.5 wt % to about 8 wt %, from about 1.75 wt % to about 8 wt %, from about 1.5 wt % to about 5 wt %, from about 1.5 wt % to about 3 wt %, from about 2 wt % to about 3 wt %, or from about 2.25 wt % to about 2.75 wt % (e.g., about 2.3 wt % or about 2.5 wt %). pH Adjustor Compounds

In various aspects of the present invention, the composition includes a pH adjustor compound. The pH adjustor compound is included along with one or more corrosion inhibitors and is believed to provide a composition with improved corrosion performance. That is, it is currently believed the pH adjustor compound improves corrosion performance of the composition in terms of steel, aluminum, brass, and/or magnesium corrosion. Metal corrosion generally is understood to be associated with anodic and/or cathodic reaction at certain environments. At regulated pH conditions, metal corrosions can be reduced through decreasing the metals' dissolution rates and forming passive film protection. For example, aluminum metal is typically inert in neutral pH or near-neutral pH solutions, while direct dissolution of the aluminum metal and electrochemical formation/dissolution of the aluminum hydroxide films prevail in concentrated alkaline or acidic solutions. Typically, the pH adjustor compound improves the corrosion performance, where necessary, with respect to any or all of the metals of interest (i.e., steel, aluminum, brass, and magnesium) such that the composition meets all existing corrosion requirements.

The pH adjustor is typically included to regulate the pH value of the fire retardant composition within a range of from about 4 to about 10 (e.g., from about 5 to about 9, or from about 6 to about 8), and the pH adjustor typically is present in a concentration of from about 1 wt % to about 5 wt %, from about 1 wt % to about 4 wt %, or from about 2 wt % to about 4 wt % (e.g., from about 2 wt % to about 3 wt %).

The pH adjustor may be selected from the group consisting of monocarboxylic acids, dicarboxylic acids, tricarboxylic acids, phosphate compounds, and combinations thereof. Suitable pH adjustors include acetic acid, malic acid, oxalic acid, citric acid, and combinations thereof. In certain embodiments, the pH adjustor comprises monoammonium phosphate (MAP), monosodium phosphate, or a combination thereof.

Overall, the pH adjustor typically is present in the composition in a weight ratio to the at least one carbonate salt of from about 0.05:1 to about 1:1, from about 0.1:1 to about 0.8:1, from about 0.1:1 to about 0.6:1, from about 0.15:1 to about 0.6:1, or from about 0.2:1 to about 0.4:1.

### Corrosion Inhibitors

In various embodiments, the concentrates of the present invention further comprise a corrosion inhibitor. Generally, the corrosion inhibitor component may be present in a concentration of from about 0.05 wt % to about 50 wt %, relative to the weight of the carbonate fire retardant. M ore particularly, the corrosion inhibitor component may be present in a concentration of from about 0.1 wt % to about 40 wt %, from about 0.1 wt % to about 30 wt %, from about 0.1 wt % to about 20 wt %, from about 0.1 wt % to about 10 wt %, or from about 0.1 wt % to about 5 wt %, relative to the weight of the carbonate fire retardant.

Various suitable corrosion inhibitors are listed below. It is to be understood that one or more of each type of corrosion inhibitor may be incorporated and that one or more different types of corrosion inhibitors may be incorporated as well.

Without being bound by any particular theory, it is currently believed such a corrosion inhibitor may perform an anti-corrosion function by one or more mechanisms including, for example, physical adsorption, chemical deposition, and/or cationic site barrier formation. Certain corrosion inhibitors are identified accordingly below.

In various embodiments, the composition comprises one or more corrosion inhibitors selected from monocarboxylic acids, dicarboxylic acids, tricarboxylic acids, and combinations and salts thereof. In various embodiments, the one or more corrosion inhibitors are selected from formic acid and salts thereof, propionic acid and salts thereof, sorbic acid and salts thereof, cinnamic acid and salts thereof, benzoic acid and salts thereof, salicylic acid and salts thereof, fumaric acid and salts thereof, maleic acid and salts thereof, succinic acid and salts thereof, tartaric acid and salts thereof, glucolic acid and salts thereof, lactic acid and salts thereof, mandelic acid and salts thereof, benzylic acid and salts thereof, poly(ethylene glycol) dicarboxylic acid and salts thereof, and combinations thereof.

In accordance with such embodiments, the one or more corrosion inhibitors may comprise an alkali metal salt of an acid selected from the group consisting of formic acid, propionic acid, sorbic acid, cinnamic acid, benzoic acid, salicylic acid, fumaric acid, maleic acid, succinic acid, tartaric acid, glucolic acid, lactic acid, mandelic acid, benzylic acid, poly(ethylene glycol) dicarboxylic acid and salts thereof, and combinations thereof. In certain embodiments, the alkali metal salt is selected from the group consisting of sodium, potassium, lithium, cerium, and combinations thereof.

Typically, the mono-, di-, or tri-carboxylic acid or salt thereof is present in a concentration of from about 0.01 wt % to about 5.0 wt %, from about 0.1 wt % to about 3.0 wt %, from about 0.2 wt % to about 2.0 wt %, or from about 0.5 wt % to about 1.0% wt %.

In other embodiments the one or more corrosion inhibitors for at least one of steel, aluminum, brass, and/or magnesium comprise a fatty acid or a salt thereof, the fatty acid having an aliphatic chain of from 8 to 26 carbon atoms. In various embodiments, the fatty acid is selected from the group consisting of caprylic acid, palmic acid, lauric acid, myristic acid, palmitic acid, stearic acid, and combinations thereof. In certain embodiments, the corrosion inhibitor comprises an alkali metal salt of a fatty acid, wherein the alkali metal is selected from the group consisting of sodium, potassium, and combinations thereof. For example, suitable corrosion inhibitors include sodium or potassium caprylate, caprate, laurate, myristate, palate, stearate, and combinations thereof.

Typically, any fatty acid or salt thereof is present in a concentration of from about 0.01 wt % to about 5.0 wt %, from about 0.1 wt % to about 3.0 wt %, from about 0.2 wt % to about 2.0 wt %, or from about 0.5 wt % to about 1.0% wt %.

Further in accordance with the present invention, the one or more corrosion inhibitors for at least one of steel, aluminum, brass, and/or magnesium comprise a water soluble divalent cation compound comprising a divalent cation selected from the group consisting of calcium, magnesium, and/or barium.

In various embodiments, the divalent cation compound comprises a calcium compound selected from the group consisting of anhydrous calcium oxide or a hydrate thereof, anhydrous calcium hydroxide or a hydrate thereof, anhydrous calcium nitrate or a hydrate thereof, anhydrous calcium acetate or a hydrate thereof, anhydrous calcium chloride or a hydrate thereof, and combinations thereof.

In other embodiments, the water soluble divalent cation compound comprises magnesium, the divalent cation compound being selected from the group consisting of magnesium chloride or a hydrate thereof, magnesium sulfate or a hydrate thereof, magnesium sulfite or a hydrate thereof, magnesium nitrate or a hydrate thereof, and combinations thereof.

In still further embodiments, the water soluble divalent cation compound comprises barium, the divalent cation compound being selected from the group consisting of barium chloride, barium nitrate and combinations thereof.

Typically, the water-soluble divalent cation compound is present in a concentration of at least about 0.1 wt %, at least about 0.2 wt %, at least about 0.3 wt %, at least about 0.4 wt %, at least about 0.5 wt %, or at least about 0.6 wt %, and/or less than about 3 wt %, less than about 2.5 wt %, less than about 2 wt %, or less than about 1 wt %,

Overall, any calcium compound as a corrosion inhibitor typically is present in a concentration of from about 0.1 wt % to about 2.0 wt %, from about 0.4 wt % to about 1.6 wt %, or from about 0.8 wt % to about 1.2 wt %.

In various other embodiments, the one or more corrosion inhibitors for at least one of steel, aluminum, brass, and/or magnesium are selected from the group consisting of sodium dihydrogen phosphate, disodium hydrogen phosphate, trisodium phosphate, potassium dihydrogen phosphate, dipotassium hydrogen phosphate, tripotassium phosphate, monocalcium phosphate, and combinations thereof. In various such embodiments, a corrosion inhibitor comprises an alkali metal phosphate in its anhydrous form. Typically, any alkali metal phosphate is present in a concentration of from about 0.5 wt % to about 3 wt %, from about 0.7 wt % to about 2.8 wt %, from about 1.0 wt % to about 2.2 wt %, from about 1.2 wt % to about 1.8 wt %, or from about 1.2 to about 1.5 wt %.

Also in accordance with various embodiments, the one or more corrosion inhibitors for at least one of steel, aluminum, brass, and/or magnesium may comprise an organic chelating agent, that is able to form a chelate complex between the organic compound with the metal and/or absorb on the metal surface. The organic chelating agent may be selected from the group consisting of ethylenediaminetraacetic acid (EDTA), ethyleneglycol Bis(2-aminoethyl ether)-N,N,N′,N′ tetraacetic acid (EGTA), polyethylene glycol, glycerol, 4-(4-nitrophenylazo)-1-naphthol (44NIN), polyacrylic acids, 8-hydroxyquinoline, polymethacrylate, salicylaldoxime, 2-mercaptoenzothiazole, thioacetamide, quinaldic acid, alpha-benzoionoxime, 2-(2-hydroxyphenyl)benzoxazole, dithiooxamide, cuprizone, cupferron, 1,2,4-triazole, 3-amino-1,2,4-triazole, 2-mercaptobenzothiazole, and combinations thereof.

Further in accordance with the present invention, the corrosion inhibitor may comprise an organic absorption compound selected from the group consisting of ethylenediaminetraacetic acid (EDTA), ethyleneglycol bis(2-aminoethyl ether)-N,N,N′,N′ tetraacetic acid (EGTA), polyethylene glycol, glycerol, 4-(4-nitrophenylazo)-1-naphthol (44NIN), polyacrylic acids, 8-hydroxyquinoline, polymethacrylate, salicylaldoxime, 2-mercaptoenzothiazole, thioacetamide, quinaldic acid, alpha-benzoionoxime, 2-(2-hydroxyphenyl)benzoxazole, dithiooxamide, cuprizone, cupferron, 1,2,4-triazole, 3-amino-1,2,4-triazole, 2-mercaptobenzothiazole, and combinations thereof.

Typically, any organic chelating compound as a corrosion inhibitor may be present in a concentration of from about 0.01 wt % to about 2.0 wt %, from about 0.1 wt % to about 1.5 wt %, from about 0.2 wt % to about 1.2 wt %, or from 0.5 wt % to about 1.0 wt %.

In various embodiments, an organic chelating compound is present in a concentration of from about 0.01 wt % to about 2.0 wt %, from about 0.1 wt % to about 2 wt %, from about 0.1 wt % to about 1.2 wt %, or from 0.1 wt % to about 1.0 wt %.

In still further embodiments, the one or more corrosion inhibitors may comprise a surfactant selected from nonionic surfactants, anionic surfactants, and/or cationic surfactants. In accordance with certain embodiments, the surfactant is selected from the group consisting of sodium dodecyl sulfate, sodium dodecylbenzene sulfonate, sodium N-lauroylsarcosine, N-lauroyl-N-methyltaurine, fatty alcohol ethoxylates, alky phenol ethoxylates, and sorbitan esters, C8-C10 alkyamidodimethyl propylamine, alkylimethyl amine oxides, cetyl trimethylammonium chloride, didecyldimethylammonium chloride, dodecyltrimethylammonium chloride, tetrabutylammonium chloride, tetramethylammonium fluoride tetrahydrate, benzyltriethylammonium chloride, hexadecyltrimethylammonium chloride, and combinations of thereof.

Typically, any surfactant is present as a corrosion inhibitor in a concentration of from about 0.01 wt % to 0.5 wt %, from about 0.03 wt % to about 0.3 wt %, or from about 0.05 wt % to about 0.15 wt %.

### Additional Components

The concentrate composition also typically includes a flow conditioner. Typically, the flow conditioner is selected from the group consisting of phosphate flow conditioners, oxide flow conditioners, silicate flow conditioners, silica flow conditioners, cellulose containing flow conditioners, and combinations thereof. In certain embodiments, the flow conditioner constitutes from about 0.5 wt % to about 5.0 wt % of the concentrate (e.g., from about 0.5 to about 3.0 wt %).

Suitable phosphate flow conditioners are selected from the group consisting of tricalcium phosphate, magnesium phosphate, dimagnesium phosphate, trimagnesium phosphate, calcium phosphate, dicalcium phosphate, tricalcium phosphate, sodium aluminum phosphate, and combinations thereof. In various embodiments, the phosphate flow conditioner is tricalcium phosphate.

Suitable oxide flow conditioners include magnesium oxide, sodium dioxide, calcium oxide, silicon dioxide, and combinations thereof. In various embodiments, the flow conditioner is magnesium oxide. In certain embodiments, the flow conditioner comprises silicon dioxide. Silica dioxide-containing flow conditioners include silicas such as untreated fumes silica and micronized silica. Options of commercially available sources of flow conditioner include the following silicon dioxide flow conditioners: e.g., ZEOFREE 80, 110SD, 200, 5161, 5162, 265, 5191, 5193, and 5170.

Suitable silicate flow conditioners may be selected from the group consisting of calcium silicate, calcium aluminosilicate, calcium aluminum silicate, aluminum silicate, sodium silicate, sodium aluminum silicate, trisilicate, magnesium silicate, magnesium trisilicate, potassium aluminum silicate, and combinations thereof. In various embodiments, the silicate flow conditioner is selected from the group consisting of calcium silicate, aluminum silicate, sodium silicate, and combinations thereof. In various other embodiments, the flow conditioner is selected from sodium aluminosilicate, calcium silicate, aluminum silicate, and combinations thereof. Certain embodiments include calcium silicate as the flow conditioner. Options of commercially available calcium silicate flow conditioners: e.g., HUBERSORB 5121, 250, and 600. Options of commercially available sodium aluminosilicate flow conditioners: e.g., ZEOLEX 7, 201, 23A, and 7A.

Suitable cellulose containing flow conditioners are selected from the group consisting of ground rice hulls, a starch selected from potato, tapioca, and corn, bamboo powder, bamboo fiber, wheat powder, wheat fiber, oat powder, oat fiber, and combinations thereof. In certain embodiments, the flow conditioner comprises ground rice hulls.

Generally, the concentrates of the present invention may be uncolored, include a pigment (e.g., iron oxide), or be colored with a fugitive pigment. A fugitive color system may be present in a concentration of from about 1 wt % to about 3.5 wt %, from about 1.5 wt % to about 3.5 wt % (e.g., about 1.7 wt %).

In certain aspects, the pigment or dye comprises red iron oxide, brown iron oxide, titanium dioxide or a fugitive pigment or dye. In some embodiments, the pigment or dye can comprise a fugitive color system.

In some embodiments, the fugitive color system comprises a fugitive pigment and a water insoluble opaque material (e.g., an opacifier such as zinc ferrite).

Suitable color systems are described in, for example, U.S. Ser. No. 16/784,913 (US 2020/024290 A 1) and U.S. Pat. No. 11,142,698, the entire contents of which are incorporated herein by reference for all relevant purposes.

Typically, any dye or colorant is present in the concentrate at a concentration from about 0.15 wt % to about 0.35 wt %, or about 0.15 wt % of the concentrate. For example, iron oxide may be present in a concentration of from about 0.15 wt % to about 1.5 wt %, or from about 0.15 wt % to about 0.35 wt %.

For example, suitable fugitive pigment color systems include those described in U.S. Pat. No. 11,142,698, the entire contents of which are incorporated by reference herein for all relevant purposes.

As noted, it is known that the pH of a solution plays a vital role in affecting the corrosion of metal contacted with the solution. Metal corrosion derived from anodic and/or cathodic reactions usually occurs at certain pH environments. At regulated pH conditions, the metal corrosions can be reduced through decreasing the metals' dissolution rates and forming passive film protection. For example, aluminum metal is usually inert with no significant corrosion in neutral solutions, while direct dissolution of the aluminum and electrochemical formation/dissolution of the aluminum hydroxide films prevail in concentrated alkaline or acidic solutions. A carbonate salt solution typically shows strong alkaline property at high (i.e., alkaline) pH values, which may lead to surface etching and/or pitting corrosion of metals. Thus, the concentrate composition may also include a pH regulating compound. The pH regulating compound may include, but is not limited to a strong acid, a weak acid, strong base, weak base, or a combination of the above. The pH regulating compound, if included, is incorporated to ensure the pH of a solution containing the concentrate has a pH of from about 4 to about 10, from about 6 to about 9, or in certain embodiments from about 7 to about 8. Examples of suitable pH regulating compounds include strong and/or weak acids such as phosphoric acid, phosphorous acid, hypophosphorous acid, metaphosphoric acid, sulfuric acid, sulfurous acid, hyposulfurous acid, persulfuric acid, disulfurous acid, hydrosulfuric acid, hydrochloric acid, hypochlorous acid, chloric acid, acetic acid, oxalic acid, citric acid, formic acid, and any other organic acids, phosphates such as ammonium phosphates, diammonium phosphate, monoammonium phosphate, ammonium sulfate, ammonium chloride; and strong and/or weak bases such as sodium hydroxide, potassium hydroxide, ammonium hydroxide, calcium hydroxide, magnesium hydroxide, zinc hydroxide and any other metal hydroxides, ethyleneamine, ethylenediamine, diethylenetriamine, triethylnenetetraamine and other basic organic amines, and combinations thereof.

In certain embodiments, the pH regulating compound may be selected from the group consisting of phosphoric acid, sulfuric acid, hyposulfurous acid, persulfuric acid, hydrosulfuric acid, hydrochloric acid, hypochlorous acid, chlorous acid, hydrophosphoric acid, formic acid, acetic acid, citric acid, oxalic acid, oleic acid, monosodium phosphate, monoammonium phosphate, monopotassium phosphate, sodium bisulfate, disodium phosphate, diammonium phosphate, dipotassium phosphate, and combinations thereof.

It is currently believed that controlling the pH of the final retardant solution within certain ranges (e.g., from about 6 to about 9) contributes to improved corrosion properties of the retardant solutions of the present invention. M ore particularly, it is currently believed that regulating the pH of the fire retardant solution provides advantageous aluminum corrosion. In various embodiments, the pH regulating compound is selected from phosphoric acid, metaphosphoric acid, sulfuric acid, ammonium dihydrogen phosphate, acetic acid, oxalic acid, citric acid, formic acid, salicylic acid, benzoic acid, galic acid and combinations thereof.

### Liquid Concentrates

The present invention also includes liquid fire retardant concentrates prepared by diluting the powder concentrates described herein to provide a liquid fire retardant concentrate. Given that such concentrates involve partial dilution prior to forming the fire retardant solution for use, they may be termed intermediate liquid concentrates. Such concentrates typically contain from about 10 to about 50% by weight, from about 30% to about 50%, or from about 40% to about 50% by weight water.

In various embodiments, water is present in a concentration of at least about 5 wt %, at least about 10 wt %, at least 15 wt %, about 20 wt %, at least about 25 wt %, at least about 30 wt %, at least about 35 wt %, at least about 40 wt %, at least about 45 wt %, at least about 50 wt %, at least about 60 wt %, at least 70 wt % or above any of these lower limits and below at least about 75 wt %.

Further in accordance with the present invention, various aspects involve liquid fire retardant concentrate compositions in addition to the powdered concentrates discussed herein and include liquid concentrates prepared without first preparing a dry concentrate that is diluted. That is, aspects of the present invention include liquid fire retardate concentrates prepared by combining and mixing the components described therein and at the specified concentrations.

In certain aspects, the present invention is directed to a fire retardant concentrate comprising a carbonate salt fire retardant and a stability enhancing component comprising dimercaptothiadiazole (DMTD).

Other aspects are directed to a fire retardant concentrate comprising a carbonate salt fire retardant and a thickener comprising xanthan gum.

Liquid fire retardant concentrates of the present invention generally include a fire retardant, a flow conditioner a thickener, a corrosion inhibitor, and a viscosity/stability enhancing component. Other components (as described herein) may also be included in the compositions of the present invention. As noted, liquid fire retardants may be prepared from dilution of a solid concentrate or by combining the components of the concentrate with water. In either case, the concentrate composition may include any or all of the components described herein at and/or within the listed concentrations, ratios, proportions, etc.

The fire retardant concentrates of the present invention include carbonate salt as a fire retardant. Typically, carbonate salt is incorporated as potassium carbonate, sodium carbonate, ammonium carbonate, guanidine carbonate, potassium bicarbonate, sodium biocarbonate, ammonium bicarbonate and other metal carbonate salts. The concentrates of the present invention generally include carbonate salt in a proportion of at least about 75 wt %, at least about 80 wt %, at least about 85 wt %, or at least about 90 wt %. In various embodiments, the concentrates include from about 80 wt % to about 95 wt %, from about 85 wt % to about 95 wt %, or from about 90 wt % to about 95 wt %.

To reduce the proportion of carbonate based fire retardant that may be required, an ammonium phosphate-based fire retardant may be incorporated, allowing for a suitable reduction in carbonate salt loading. In certain embodiments, from about 5 wt % to about 90 wt % of an ammonium phosphate fire retardant may be incorporated.

In certain embodiments, the composition comprises from about 5 wt % to about 90 wt % carbonate salt and from about 5 wt % to about 90 wt % of ammonium phosphate-based fire retardants. In accordance with other embodiments, the composition may comprise from about 20 wt % to about 80 wt % carbonate salt (e.g., from about 40 wt % to about 60 wt %) and from about 20 wt % to about 80 wt % ammonium phosphate-based fire retardant (e.g., from about 40 wt % to about 60 wt %). The amount of each fire retardant can be selected depending on the desired balance between, for example, the amount of fire retardant to be incorporated and the desired properties to be imparted to the final composition by the individual fire retardants.

In still further embodiments, the fire retardant concentrate composition includes carbonate salts and a nitrogen-containing compound fire retardant which performs the gas-dilution fire retardancy mechanism.

### Thickener

The concentrate compositions of the present invention further comprise one or more thickeners. Representative examples of thickeners include xanthan gum, rhamsan gum, welan gum, diutan gum, guar gum, and mixtures thereof. In certain embodiments, the thickener is xanthan gum.

The thickener is typically present in a proportion of at least about 1 wt %, at least about 1.5 wt %, at least about 2 wt %, or at least about 2.5 wt %. Often, the thickener is present in a proportion of from about 1 wt % to about 3 wt %, from about 1.5 wt % to about 3 wt %, from about 2 wt % to about 3 wt %, or from about 2.25 wt % to about 2.75 wt % (e.g., about 2.5 wt %).

Further in accordance with the present invention it has been discovered that certain components may be desired to provide an improvement in viscosity and/or stability over time. Such components may be an azole stability enhancer (e.g., dimercaptothiadiazole (DMTD)).

Generally, any stability enhancing component is present in a proportion of at least about 0.1 wt %, at least about 0.2 wt %, at least about 0.3 wt %, at least about 0.4 wt %, or at least about 0.5 wt %. Typically, any stability enhancing component is present in a proportion of from about 0.1 wt % to about 1 wt %.

### Pigments/Dyes and O Pacifiers

In some embodiments, the liquid fire retardant concentrate is prepared as an uncolored formulation. However, in other embodiments, the liquid fire retardant concentrate can comprise a pigment or a dye. In certain aspects, the pigment or dye comprises red iron oxide, brown iron oxide, titanium dioxide or a fugitive pigment or dye. In some embodiments, the pigment or dye can comprise a fugitive color system.

In some embodiments, the fugitive color system comprises a fugitive pigment and a water insoluble opaque material (e.g., an opacifier such as zinc ferrite).

Suitable color systems are described in U.S. Ser. No. 16/784,913 and U.S. Provisional Patent Application No. 62/802,902, the entire contents of which are incorporated herein by reference for all relevant purposes.

### Additional Components

Further additional components of the concentrate composition may include a surfactant, a foam controlling additive (e.g., a suitable difunctional block copolymer), a biocide, and any combination thereof.

Where incorporated, such components, individually or in combination, may be present in a proportion of at least about 0.05 wt %, at least about 0.1 wt %, from about 0.05 wt % to about 1 wt %, or from about 0.1 wt % to about 0.5 wt %.

### Fire Retardant Solutions

Aspects of the present disclosure include fire retardant solutions prepared by mixing a fire-retardant concentrate composition, as described anywhere herein, with water to form an aqueous solution. In certain embodiments, a homogenous solution is formed. In certain other embodiments, the water contains low levels of bacterial contamination that can impact viscosity and/or stability by consuming biopolymers. Thus, in certain embodiments, the water contains a biocide to prevent bacterial contamination. In certain embodiments, the solution comprises insoluble components.

In certain embodiments, the solution is prepared by combining at least 5 volumes of water per volume of liquid concentrate. In certain embodiments, the ratio of water to liquid concentrate is from about 5 volumes to about 7 volumes of water to about 1 volume of liquid concentrate.

In certain other embodiments, a solution of the present disclosure is prepared by combining at least about 0.5 pounds (lbs.), at least about 0.6 lbs., at least about 0.7 lbs., at least about 0.8 lbs., at least about 0.9 lbs., at least about 1.0 lb., at least about 1.5 lbs., or at least 2 lbs. of fire retardant concentrate per gallon of water.

Reduction and/or improvements in control of metal corrosion may be evidenced by meeting and/or improving the performance of magnesium fire retardant compositions with respect to meeting USFS Specification 5100-304d, January 2020, including any and all amendments and updates to this Specification and/or other standards or requirements that may be established for assessing metal corrosion by the USFS or other regulatory bodies. Accordingly, the regulatory metal corrosion requirements may comprise or consist of USFS Specification 5100-304d (Jan. 7, 2020, including any and all amendments).

In certain embodiments, a fire-retardant solution meets one or more of the required criteria for of U.S. Department of Agriculture, Forest Service, Specification Number 5100-304d, January 2020, including any and all amendments.

In certain embodiments, a fire-retardant solution meets one or more of the required criteria for corrosion and/or stability of U.S. Department of Agriculture, Forest Service, Specification Number 5100-304d, January 2020, including all amendments.

In certain embodiments, a fire-retardant solution meets all of the required criteria for corrosion of U.S. Department of Agriculture, Forest Service, Specification Number 5100-304d, January 2020, including all amendments.

For example, various embodiments of the present invention involve fire retardant solutions that may and typically or preferably meet one or more, or all of the metal corrosion standards established in USFS Specification 5100-304d (Jan. 7, 2020), entitled “Long-Term Retardant, Wildland Firefighting.” A wildland fire retardant solution can qualify for application for use with fixed tank helicopters when the maximum corrosion rates for 2024 T3 aluminum, 4130 steel, yellow brass and AZ-31-B magnesium are not higher than 2 milli-inch per year (MPY), 5 MPY, 5 MPY and 4 MPY, respectively. For qualification of use with fixed-wing air tankers, the maximum allowable corrosion rate of a wildland fire retardant solution to aluminum is 2 MPY, and maximum corrosion rates to steel and brass is 5 MPY while corrosion to magnesium is not required.

The present invention thus involves fire retardant solutions that may typically or preferably exhibit aluminum (e.g., 2024T 3 aluminum) corrosion of less than about 5 MPY, less than about 4.5 MPY, less than about 4 MPY, less than about 3.5 MPY, less than about 3 MPY, less than about 2.5 MPY, less than about 2 MPY, less than about 1.5 MPY, less than about 1 MPY, or less than about 0.5 MPY.

Additionally, or alternatively, the present invention involves fire retardant solutions that may typically or preferably exhibit steel (e.g., 4130 steel) corrosion of less than about 5 MPY, less than about 4.5 MPY, less than about 4 MPY, less than about 3.5 MPY, less than about 3 MPY, less than about 2.5 MPY, less than about 2 MPY, less than about 1.5 MPY, less than about 1 MPY, or less than about 0.5 MPY.

The present invention also involves fire retardant solutions that may typically or preferably exhibit yellow brass corrosion of less than about 5 MPY, less than about 4.5 MPY, less than about 4 MPY, less than about 3.5 MPY, less than about 3 MPY, less than about 2.5 MPY, less than about 2 MPY, less than about 1.5 MPY, less than about 1 MPY, or less than about 0.5 MPY.

Further additionally or alternatively, the fire retardant solutions may typically or preferably exhibit magnesium (e.g., AZ-31-B magnesium) corrosion of 5 MPY, less than about 4.5 MPY, less than about 4 MPY, less than about 3.5 MPY, less than about 3 MPY, less than about 2.5 MPY, less than about 2 MPY, less than about 1.5 MPY, less than about 1 MPY, or less than about 0.5 MPY.

In certain embodiments, the present invention involves fire retardant compositions (e.g., fire retardant solutions and concentrates diluted to prepare fire retardant solutions) that may typically or preferably meet the applicable steel, yellow brass and magnesium corrosion standards. A pH regulating compound may be included, thereby providing a composition also meeting the applicable aluminum corrosion standards.

In certain embodiments, a fire-retardant solution meets all of the required criteria for stability of U.S. Department of Agriculture, Forest Service, Specification Number 5100-304d, January 2020, including all amendments.

In certain embodiments, a fire-retardant solution meets all of the required criteria for corrosion and stability of U.S. Department of Agriculture, Forest Service, Specification Number 5100-304d, January 2020, including all amendments.

In certain embodiments, a fire-retardant solution meets all of the required criteria of U.S. Department of Agriculture, Forest Service, Specification Number 5100-304d, January 2020, including all amendments.

Further in accordance with the foregoing, the metal corrosion results for the compositions of the present invention may meet or exceed regulatory metal corrosion requirements set forth above under one or more of the following conditions: room temperature total immersion (RTT), room temperature partial immersion (RTP), elevated temperature total immersion (ETT), and elevated temperature partial immersion (ETP), including the conditions detailed herein in the working examples.

In certain embodiments, the fire-retardant solution exhibits a viscosity in the range of from about 100 cPs to about 1500 cPs, from about 100 cPa to about 1000 cps, or from about 100 cPs to about 800 cPs, or from about 100 cPs to about 300 cPs when measured in accordance with Specification 5100-304d, January 2020, including any and all amendments.

The disclosed solutions also exhibit low aquatic toxicity. For example, in certain embodiments, a solution exhibits an aquatic toxicity (LC50) in the range of from about 180 milligrams per liter to about 1500 milligrams per liter. In certain embodiments, a solution exhibits an aquatic toxicity (L C50) greater than about 180, 200, 500, 1000, 2000, or 2500 milligrams per liter. In certain embodiments, a solution exhibits an aquatic toxicity (LC50) in the range of from any of about 180, 200, 500, 750, 1000, 2000, or 2500 milligrams per liter to any of about 200, 500, 1000, 2000, 2500, or 2700 milligrams per liter (e.g., about 980 milligrams per liter).

In certain embodiments, a fire-retardant solution has a pH in the range of from about pH 4.0 or 5.0 to about pH 10.0. In certain embodiments, a fire-retardant solution has a pH in the range of from about pH 6.0 about pH 10.0. In certain embodiments, a fire-retardant solution has a pH in the range of from about pH 6.0 to about pH 10.0 (e.g., from about 6.0 to about 10.0 or from about 6.0 to about 9.5). In certain embodiments, a fire-retardant solution has a pH in the range of from about pH 9.0. to about pH 9.3. In certain embodiments, a fire-retardant solution has an alkaline pH.

In certain embodiments, visibility of the applied solution is improved, allowing firefighting forces to draw an effective chemical fire barrier using less total solution.

### Methods of Combatting a Wildfire

Disclosed herein are methods of combatting a wildfire by applying a fire-retardant solution described anywhere herein for the purpose of suppressing, containing, controlling, or extinguishing, etc., a wildfire. In certain embodiments, the fire-retardant solution is applied directly onto a flaming fuel. In other embodiments, the fire-retardant solution is applied indirectly, e.g., in front of or parallel to the moving fire front. The distance between the advancing fire and the retardant fire-break depends on the rate that the solution can be applied, the rate of spread of the moving fire front, and the presence or absence of a natural fuel break identified by changes in the geometry of the ground being threatened. In certain embodiments, the fire-retardant solution is applied from a ground platform such as a fire-engine. In these and certain other embodiments, the fire-retardant solution is applied from an aerial platform such as a fixed-wing aircraft or a rotary-wing aircraft. For example, in certain embodiments, the fire-retardant solution is applied from a rotary-wing aircraft such as a helicopter utilizing a bucket which is slung below the helicopter and in other embodiments the fire-retardant solution is contained within tanks mounted in or attached externally to the helicopter. In other embodiments, the fire retardant solution is applied from a mix of all of those listed vehicles or platforms. Obviously, the safety of the solution relative to aircraft corrosion and fouling of critical components must be greater when the solution is within or in contact with the aircraft.

Described herein are various embodiments of compositions of the present invention including one or more corrosion inhibitors (typically along with a pH adjustor compound) incorporating one or more types of corrosion inhibitors described herein. For example, suitable corrosion inhibitors include various fatty acids and salts thereof (e.g., alkali metal salts such as sodium and potassium salts). Other suitable corrosion inhibitors include water soluble divalent cation compounds containing, for example, calcium, magnesium, or barium; various phosphate compounds; and various organic chelating compounds. See, for example, the EMBODIMENTS section herein. Other compounds suitable as corrosion inhibitors may also be referred to as surfactants in other contexts.

Such corrosion inhibitors may be combined with other corrosion inhibitors (e.g., azole corrosion inhibitors listed herein and known in the art). In various embodiments of the present invention, the composition includes one or more of such corrosion inhibitor(s) without including any azole and/or molybdate corrosion inhibitor(s). In this manner, the composition is substantially free or free of any azole and/or molybdate corrosion inhibitor. Stated another way, the composition includes a corrosion inhibitor component that consists essentially thereof or consists of the corrosion inhibitors described herein (e.g., in the EMBODIMENTS) section.

The compositions may further include a corrosion inhibitor include one of the corrosion inhibitors such as those listed in the EMBODIMENTS section along with an azole corrosion inhibitor and/or molybdate corrosion inhibitor. Typically in accordance with such embodiments, the non-azole, non-molybdate corrosion constitutes at least about or about 30 wt %, at least about or about 40 wt %, at least about or about 50 wt %, at least about or about 60 wt %, at least about or about 70 wt %, at least about or about 75 wt %, at least about or about 80 wt %, at least about or about 85 wt %, at least about or about 90 wt %, at least about or about 95 wt %, at least about or about 99 wt % of the corrosion inhibitor component. The non-azole, non-molybdate corrosion inhibitor may also be present within a range defined by the listed amounts as the lower and upper limits (e.g., from about 60 wt % to about 95 wt %, or from about 60 wt % to about 90 wt %).

Further in accordance with the present invention, the composition may include as a corrosion inhibitor within the concentrations and ratios described herein a component that may be designated otherwise. For example, certain components that may referred to as surfactants (e.g., sodium N-laurylsarcosine) may be incorporated and may distinguish use of such a component for another purpose in either form (e.g., concentration(s), relative proportion(s), etc.) or function.

In accordance with the present invention, typically the fire retardant component and a corrosion inhibitor described herein (e.g., a non-azole, non-molybdate corrosion inhibitor) are present in a weight ratio of the retardant to corrosion inhibitor of at least about 10:1, at least about 15:1; at least about 20:1, at least about 25:1, at least about 30:1, at least about 35:1, at least about 40:1, at least about 45:1, at least about 50:1, at least about 55:1, at least about 60:1, at least about 65:1, at least about 70:1, at least about 75:1, at least about 80:1, at least about 85:1, or at least about 90:1.

A pH adjustor may be present at a weight ratio to the corrosion inhibitor (e.g., non-azole, non-molybdate corrosion inhibitor) of at least about 4:1, at least about 5:1, at least about 10:1, at least about 15:1, at least about 20:1, at least about 25:1, at least about 30:1, at least about 40:1, or at least about 50:1.

Citric Acid pH-Adjusted Compositions

Further in accordance with the present disclosure and the other embodiments discussed elsewhere herein, the present invention includes citric acid containing compositions typically having been pH adjusted and/or having their pH controlled within certain limits and ranges currently believed to contribute to one or more advantageous performance properties. Such advantageous performance properties are typically observed in connection with metal corrosion when formulations are tested in accordance with U.S. Forest Service (USFS) standard testing methods. Various such embodiments include a potassium carbonate fire retardant in accordance with the disclosure appearing elsewhere herein.

For example, various embodiments of the present invention involve fire retardant solutions that may and typically or preferably meet one or more, or all of the metal corrosion standards established in USFS Specification 5100-304d (Jan. 7, 2020), entitled “Long-Term Retardant, Wildland Firefighting” and/or other standards that may established for assessing metal corrosion by the USFS or other regulatory bodies. A wildland fire retardant solution can qualify for application for use with fixed tank helicopters when the maximum corrosion rates for 2024 T3 aluminum, 4130 steel, yellow brass and AZ-31-B magnesium are not higher than 2 milli-inch per year (MPY), 5 MPY, 5 MPY and 4 MPY, respectively. For qualification of use with fixed-wing air tankers, the maximum allowable corrosion rate of a wildland fire retardant solution to aluminum is 2 MPY, and maximum corrosion rates to steel and brass is 5 MPY while corrosion to magnesium is not required.

Compositions of the present invention include as-prepared, finally prepared and/or ready for use compositions prepared by diluting a fire retardant concentrate in accordance with the present disclosure.

Typically, the citric acid pH-adjusted compositions have a pH of less than (about) 10.6, less than (about) 10.4, less than (about) 10.2, less than (about) 10.0, less than (about 9.8), or even less than (about) 9.6. The citric acid pH adjustor compound is typically present in a concentration of at least about 0.5 wt %, at least about 1.0 wt %, at least about 1.5 wt %, or even at least about 2.0 wt %. The citric acid thus may be present in a concentration of from about 0.5 wt % to about 4.0 wt %, from about 1.0 wt % to about 3.0 wt % (e.g., from about 2.0 wt % to about 3.0 wt %), or from about 1.0 to about 2.0 wt %.

A long with the citric acid pH adjustor and potassium carbonate fire retardant, these compositions typically include one or more thickeners (e.g., a biopolymer thickener), pigments (e.g., fugitive pigments), opacifiers, and/or thickeners. Along with these components, the compositions include one or more corrosion inhibitors.

Suitable corrosion inhibitors include molybdate corrosion inhibitors, azole corrosion inhibitors (e.g., tolytriazole corrosion inhibitors). Other suitable corrosion inhibitors include phosphate compounds (e.g., monosodium phosphate), calcium compounds (e.g., calcium nitrate), magnesium compounds (e.g., magnesium sulfate), fatty acids and salts thereof (e.g., lauric acid and sodium stearate), and aromatic carboxylate corrosion inhibitors (e.g., sodium benzoate and sodium salicylate).

Typically, any corrosion inhibitor is present in a concentration of at least about 0.1 wt %, at least about 0.2 wt %, at least about 0.3 wt %, at least about 0.4 wt %, or at least about 0.5 wt %. Generally, in such embodiments, any corrosion inhibitor is present in a concentration of from about 0.1 wt % to about 2.0 wt %, from about 0.1 wt % to about 1.5 wt %, or from about 0.2 wt % to about 1.0 wt %.

Suitable phosphate compounds as corrosion inhibitors include monosodium phosphate, sodium dihydrogen phosphate, disodium hydrogen phosphate, trisodium phosphate, potassium dihydrogen phosphate, dipotassium hydrogen phosphate, tripotassium phosphate, monocalcium phosphate, and combinations thereof.

Suitable calcium compounds as corrosion inhibitors include anhydrous calcium oxide or a hydrate thereof, anhydrous calcium hydroxide or a hydrate thereof, anhydrous calcium nitrate or a hydrate thereof, anhydrous calcium acetate or a hydrate thereof, anhydrous calcium chloride or a hydrate thereof, and combinations thereof.

Suitable magnesium compounds as corrosion inhibitors include magnesium chloride or a hydrate thereof, magnesium sulfate or a hydrate thereof, magnesium sulfite or a hydrate thereof, magnesium nitrate or a hydrate thereof, and combinations thereof.

Suitable fatty acid compounds and salts thereof include fatty acids selected from the group consisting of caprylic acid, palmic acid, lauric acid, myristic acid, palmitic acid, stearic acid, and combinations thereof, and alkali metal salts thereof.

Suitable aromatic carboxylate corrosion inhibitors include sodium benzoate and sodium salicylate.

A long with the components listed above, it is currently believed that providing as prepared or ready for use formulations exhibiting certain pHs and/or viscosities provides one or more performance advantages. For example, it has been observed that formulations having a pH of less than 10 or even lower exhibit improved metal corrosion. See, for example, Examples 15, 19, and 20. Additionally, or alternatively, it is currently believed that incorporating a fatty acid (e.g., lauric acid) or a calcium compound (e.g., calcium nitrate) as a corrosion inhibitor provides improved metal corrosion in terms of any or all corrosion testing, including aluminum, steel, and/or brass corrosion.

Further in accordance with these and various other compositions, it is currently believed that formulations having viscosities within certain ranges or below certain limits provide improved performance in terms of metal corrosion. Such compositions are generally considered to exhibit middle or even relatively low viscosities when considered and compared to other formulations.

Typically, compositions of the present invention having viscosities (e.g., when measured in accordance with Specification 5100-304d, January 2020, including any and all amendments) of less than about 1000 centipoise (cP), less than about 900 cP, less than about 800 cP, less than about 700 cP, less than about 600 cP, less than about 500 cP, or less than about 400 cP. Typically, compositions exhibiting improved corrosion performance have viscosities of from about 200 cP to about 800 cP, or from about 400 cP to about 600 cP. Compositions exhibiting such viscosities may exhibit improved metal corrosion in terms of any or all corrosion testing, including aluminum, steel, and/or brass corrosion. See, for example, Example 17. In various embodiments, low viscosity formulations may refer to having viscosities below (about) 400 cP, while medium viscosity formulations may refer to having viscosities in a range of from (about) 400 to (about) 800 CP.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above without departing from the scope of the invention, it is intended that all matter contained in the above description shall be interpreted as illustrative and not in a limiting sense.

### EXAMPLES

The following non-limiting examples are provided to further illustrate the present invention.

### Example 1

A potassium carbonate based liquid fire retardant composition was prepared with tolytriazole and molybdate as the corrosion inhibitors. The detailed formula composition is shown in Table 1A. The physical characteristics of the as-prepared formulation indicate pH of 11.74, specific gravity of 1.094 g/ml, refractive index of 11.0 and viscosity of 280 cP. The 90-day corrosion test of the as-prepared formulation resulted in corrosion rates of less than 1.0 mpy for brass, steel and magnesium. The corrosion rates for aluminum alloy were 3.0-8.0 mpy, which are higher than the USFS acceptable corrosion rates of 2.0 mpy. Table 1B shows the detailed corrosion test results.

Unless otherwise indicated, the corrosion inhibition tests described herein were conducted in accordance with USFS Specification 5100-304d (Jan. 7, 2020), based on 90-day immersion weight loss tests. Briefly, nominally 1 inch by 4 inch by 0.125 inch metal testing coupon were measured to determine their precise dimension and engraved with a unique identifier. The coupons were then degreased, acid washed to remove oxidation films, rinsed with distilled water, dried, and weighed. Each testing coupon was then immersed either fully or partially by configuration in a glass jar containing either 800 ml or 400 ml fire-retardant composition. The glass jars were placed in 70° F. room temperature environment or an incubator at temperature of 120° F. Each formulation was subjected to the following four testing conditions, i.e., room temperature total immersion (RTT), room temperature partial immersion (RTP), elevated temperature total immersion (ETT), and elevated temperature partial immersion (ETP). Duplicates were tested for each testing condition. After 90 days incubation, the testing coupons were removed from the testing jars and subjected to acid washing, distilled water rinsing and drying before weighing. The weight change of each testing coupon before and after 90-day incubation test was used to calculate the corrosion rate which is extrapolated from 90 days to be expressed in mils per year (mpy).

As noted above, currently USFS Specification 5100-304d establishes the following metal corrosion (rates) in terms of milli-inches per year (mpy) for aluminum (2 mpy), steel (5 mpy), yellow brass (5 mpy) and magnesium (4 mpy).

TABLE 1A
Diluted liquid fire retardant composition of Example 1

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Water | 80-95% |
| Total weight of fire retardant composition | 100% |

TABLE 1B
90-day corrosion testing results of Example 1

| Metal | Testing conditions | Corrosion rate/mpy* |
|---|---|---|
| AZ-31-B magnesium | RTT | 0.8 |
| | RTP | 0.6 |
| | ETT | 0.2 |
| | ETP | 0.2 |
| 2024 T3 aluminum | RTT | 3.0 |
| | RTP | 3.3 |
| | ETT | 8.0 |
| | ETP | 4.3 |
| 4130 steel | RTT | 0.0 |
| | RTP | 0.0 |
| | ETT | 0.0 |
| | ETP | 0.0 |
| Yellow brass | ETP | 0.1 |

*Milli-inches per year (MPY)

### Example 2

Citric acid may be used as a pH adjustor to prepare a potassium carbonate based liquid fire retardant composition with pH value lower than 10. The detailed formula composition is shown in Table 2A. The physical characteristics of an as-prepared formulation may show pH of 9.97, specific gravity of 1.093 g/ml, refractive index of 11.4 and viscosity of 280 cP.

TABLE 2A
Diluted liquid fire retardant composition of Example 2

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Water | 78-93% |
| Total weight of fire retardant composition | 100% |

### Example 3

Monoammonium phosphate may be used as a pH adjustor to prepare a potassium carbonate based liquid fire retardant composition with pH value lower than 10. The detailed formula composition is shown in Table 3A. The physical characteristics of an as-prepared formulation may show pH of 9.96, specific gravity of 1.095 g/ml, refractive index of 12.5 and viscosity of 680 cP.

TABLE 3A
Diluted liquid fire retardant composition of Example 3

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Monoammonium phosphate pH adjustor | 2.0-3.0% |
| Water | 78-93% |
| Total weight of fire retardant composition | 100% |

### Example 4

A soluble calcium compound may be incorporated as corrosion inhibitor for preparing a potassium carbonate based liquid fire retardant composition. The detailed formula is listed in Table 4A. The pH value of an as-prepared formula may be lower than 10, while the formula may show viscosity higher than 400 cP.

TABLE 4A
Diluted liquid fire retardant composition of Example 4

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Calcium nitrate corrosion inhibitor | 0.2-1.0% |
| Water | 77-92% |
| Total weight of fire retardant composition | 100% |

### Example 5

A soluble magnesium compound may be incorporated as a corrosion inhibitor for preparing a potassium carbonate based liquid fire retardant composition. The detailed formula is listed in Table 5A. The pH value of an as-prepared formula may be lower than 10, while the formula may show viscosity higher than 400 cP.

TABLE 5A
Diluted liquid fire retardant composition of Example 5

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Magnesium sulfate corrosion inhibitor | 0.5-2.0% |
| Water | 77-92% |
| Total weight of fire retardant composition | 100% |

### Example 6

A fatty acid may be formulated as corrosion inhibitor to prepare a potassium carbonate based liquid fire retardant composition. The detailed formula is shown in Table 6A. The pH value of an as-prepared formula may be lower than 10, while the formula may show viscosity higher than 400 cP.

TABLE 6A
Diluted liquid fire retardant composition of Example 6

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Lauric acid corrosion inhibitor | 0.1-1.0% |
| Water | 77-92% |
| Total weight of fire retardant composition | 100% |

### Example 7

A salt of fatty acid may be used as corrosion inhibitor to prepare a potassium carbonate based liquid fire retardant composition. The detailed formula is shown in Table 7A. The pH value of an as-prepared formula may be lower than 10, while the formula may show viscosity higher than 400 cP.

TABLE 7A
Diluted liquid fire retardant composition of Example 7

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Sodium stearate corrosion inhibitor | 0.1-1.0% |
| Water | 77-92% |
| Total weight of fire retardant | 100% |
| composition | |

### Example 8

A phosphate salt may be used as corrosion inhibitor to prepare a potassium carbonate based liquid fire retardant composition. The detailed formula is shown in Table 7A. The pH value of an as-prepared formula may be lower than 10, while the formula may show viscosity higher than 400 cP.

TABLE 8A
Diluted liquid fire retardant composition of Example 8

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Monosodium phosphate corrosion | 0.1-1.0% |
| inhibitor | |
| Water | 77-92% |
| Total weight of fire retardant | 100% |
| composition | |

### Example 9

A surfactant may be used as corrosion inhibitor to prepare a potassium carbonate based liquid fire retardant composition. The detailed formula is shown in Table 9A. The pH value of an as-prepared formula may be lower than 10, while the formula may show viscosity higher than 400 cP.

TABLE 9A
Diluted liquid fire retardant composition of Example 9

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Surfactant SDBS corrosion inhibitor | 0.01-0.5% |
| Water | 77-92% |
| Total weight of fire retardant | 100% |
| composition | |

### Example 10

An organic absorption compound may be used as corrosion inhibitor to prepare a potassium carbonate based liquid fire retardant composition. The detailed formula is shown in Table 10A. The pH value of an as-prepared formula may be lower than 10, while the formula may show viscosity higher than 400 cP.

TABLE 10A
Diluted liquid fire retardant composition of Example 10

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Organic absorption compound PEG | 0.1-1.0% |
| (polyethylene glycol) corrosion | |
| inhibitor | |
| Water | 77-92% |
| Total weight of fire retardant | 100% |
| composition | |

### Example 11

A soluble calcium compound (Ca(NO₃)₂) was used as a corrosion inhibitor for preparing a potassium carbonate based liquid fire retardant composition. A representative formula is listed in Table 11A. The pH value of an as-prepared formula is approximately 10.5.

TABLE 11A
Diluted liquid fire retardant composition of Example 11

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Molybdate corrosion inhibitor | 0.01-0.05% |
| Phosphate corrosion inhibitor | 0.5-2% |
| Calcium nitrate corrosion inhibitor | 0.2-1.0% |
| Water | 82-95% |
| Total weight of fire retardant | 100% |
| composition | |

Formulation details and corrosion (corr) testing results.

The corrosion inhibition tests described herein were conducted in accordance with USFS Specification 5100-304d (Jan. 7, 2020), based on 90-day immersion weight loss tests. Briefly, nominally 1 inch by 4 inch by 0.125 inch metal testing coupon were measured to determine their precise dimension and engraved with a unique identifier. The coupons were then degreased, acid washed to remove oxidation films, rinsed with distilled water, dried, and weighed. Each testing coupon was then immersed either fully or partially by configuration in a glass jar containing either 800 ml or 400 ml fire-retardant composition. The glass jars were placed in 70° F. room temperature environment or an incubator at temperature of 120° F. Each formulation was subjected to the following four testing conditions, i.e., room temperature total immersion (RTT), room temperature partial immersion (RTP), elevated temperature total immersion (ETT), and elevated temperature partial immersion (ETP). Duplicates were tested for each testing condition. After 90 days incubation, the testing coupons were removed from the testing jars and subjected to acid washing, distilled water rinsing and drying before weighing. The weight change of each testing coupon before and after 90-day incubation test was used to calculate the corrosion rate which is extrapolated from 90 days to be expressed in mils per year (mpy).

| | Viscosity, | 10-min | 680 |
|---|---|---|---|
| | cP | 24-hr | 700 |
| pH | | | 10.53 |
| Specific gravity (S.G.), g/ml | | | 1.0983 |
| Refractive Index (R.I.) | | | 12.5 |
| | Steel corr | RTT | 0.01 |
| | | RTP | 0.02 |
| | | ETT | 0.6 |
| | | ETP | 0.02 |
| | Al. corr | RTT | 1.0 |
| | | RTP | 0.7 |
| | | ETT | 7.7 |
| | | ETP | 43.2 |
| | Brass | ETP | 0.2 |

### Example 12

Citric acid was used as a pH adjustor to prepare a potassium carbonate based liquid fire retardant composition along with a phosphate corrosion inhibitor. A representative formulation is provided below. The pH of the as-prepared formula was approximately 10.4.

TABLE 12A
Diluted liquid fire retardant composition of Example 12

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.6% |
| Opacifier | 0.01-0.05% |
| Flow conditioner | 0.05-0.5% |
| Phosphate corrosion inhibitor | 1.0-2.0% |
| Molybdate corrosion inhibitor | 0.01-0.05% |
| Citric acid pH adjustor | 0.01-1.0% |
| Water | 80-94% |
| Total weight of fire retardant | 100% |
| composition | |

Formulation details and corrosion (corr) testing results.

| | | |
|---|---|---|
| Viscosity, | 10-min | 620 |
| cP | 24-hr | 640 |

| | |
|---|---|
| pH | 10.43 |
| Specific gravity (S.G.), g/ml | 1.0973 |
| Refractive Index (R.I.) | 12.8 |

| | | |
|---|---|---|
| Steel corr | RTT | 0.02 |
| | RTP | 0.02 |
| | ETT | 0.6 |
| | ETP | 0.04 |
| Al. corr | RTT | 6.0 |
| | RTP | 3.7 |
| | ETT | 12.3 |
| | ETP | 27.5 |
| Brass | ETP | 0.04 |

### Example 13

Citric acid was used as a pH adjustor to prepare a potassium carbonate based liquid fire retardant composition along with soluble calcium compound (Ca(NO₃)₂). A representative formulation is provided below. The pH of the as-prepared formula was approximately 10.8.

TABLE 13A
Diluted liquid fire retardant composition of Example 13

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.6% |
| Opacifier | 0.01-0.05% |
| Flow conditioner | 0.05-0.5% |
| Calcium nitrate corrosion inhibitor | 0.1-1.0% |
| Molybdate corrosion inhibitor | 0.01-0.05% |
| Citric acid pH adjustor | 0.01-1.0% |
| Water | 82-95% |
| Total weight of fire retardant | 100% |
| composition | |

Formulation details and corrosion (corr) testing results.

| | | |
|---|---|---|
| Viscosity, | 10-min | 680 |
| cP | 24-hr | 700 |

| | |
|---|---|
| pH | 10.83 |
| Specific gravity (S.G.), g/ml | 1.0931 |
| Refractive Index (R.I.) | 11.7 |

| | | |
|---|---|---|
| Steel corr | RTT | 0.02 |
| | RTP | 0.01 |
| | ETT | 2.3 |
| | ETP | 0.1 |
| Al. corr | RTT | 0.4 |
| | RTP | 0.2 |
| | ETT | 17.7 |
| | ETP | 14.8 |
| Brass | ETP | 0.1 |

### Example 14

Citric acid was used as a pH adjustor to prepare a potassium carbonate based liquid fire retardant composition. A representative formulation is provided below. The pH of the as-prepared formula was approximately 10.8.

TABLE 14A
Diluted liquid fire retardant composition of Example 14

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.6% |
| Opacifier | 0.01-0.05% |
| Flow conditioner | 0.05-0.5% |
| Molybdate corrosion inhibitor | 0.01-0.05% |
| Citric acid pH adjustor | 0.01-1.0% |
| Water | 82-95% |
| Total weight of fire retardant | 100% |
| composition | |

Formulation details and corrosion (corr) testing results.

| | | |
|---|---|---|
| Viscosity, | 10-min | 540 |
| cP | 24-hr | 600 |

| | |
|---|---|
| pH | 10.86 |
| Specific gravity (S.G.), g/ml | 1.0827 |
| Refractive Index (R.I.) | 12 |

| | | |
|---|---|---|
| Steel corr | RTT | 0.02 |
| | RTP | 0.02 |
| | ETT | 0.4 |
| | ETP | 0.03 |
| Al. corr | RTT | 0.4 |
| | RTP | 0.2 |
| | ETT | 2.5 |
| | ETP | 9.7 |
| Brass | ETP | 0.1 |

### Example 15

The following examples details a formulation and corrosion testing for a composition as also described in Example 2 above incorporating citric acid. Citric acid was used as a pH adjustor to prepare a potassium carbonate based liquid fire retardant composition with pH value lower than 10. The detailed formula composition is shown in Table 15A. The physical characteristics of an as-prepared low viscosity formulation show pH of 9.97, specific gravity of 1.093 g/ml, refractive index of 11.4 and viscosity of 280 cP. The 90-day corrosion test of the as-prepared formulation resulted in corrosion rates of less than 5.0 mpy for brass and steel, meeting the requirements of USFS acceptable corrosion rates. The corrosion rates for aluminum alloy tested at elevated temperature were 2.0-3.2 mpy, which are higher than the USFS acceptable corrosion rates of 2.0 mpy. Based on a comparison to aluminum corrosion results for other formulations (e.g., in Example 12), lowering pH value of the formulation with citric acid can significantly reduce the corrosion to aluminum alloy, suggesting an effective method of reducing corrosion of fire-retardant formulations. Table 15B shows the detailed corrosion test results.

TABLE 15A
Diluted liquid fire retardant composition of Example 15

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Water | 78-93% |
| Total weight of fire retardant composition | 100% |

TABLE 15B
90-day corrosion testing results of Example 15

| Metal | Testing conditions | Corrosion rate/mpy |
|---|---|---|
| 2024 T3 aluminum | RTT | 0.4 |
| | RTP | 0.2 |
| | ETT | 3.2 |
| | ETP | 2.0 |
| 4130 steel | RTT | 0.0 |
| | RTP | 0.0 |
| | ETT | 3.5 |
| | ETP | 0.0 |
| Yellow brass | ETP | 0.2 |

### Example 16

The following examples details a formulation and corrosion testing for a composition as also described in Example 2 above incorporating citric acid. Citric acid was used as a pH adjustor to prepare a potassium carbonate based medium viscosity liquid fire retardant composition with pH value lower than 10. The detailed formula composition is shown in Table 16A. The physical characteristics of as prepared medium viscosity formulation show pH of 9.97, specific gravity of 1.09 g/ml, refractive index of 11.6 and viscosity of 590 cP. The 90-day corrosion test of the as-prepared formulation resulted in corrosion rates of less than 1 mpy for brass meeting the requirements of USFS acceptable corrosion rates. The corrosion rates tested at elevated temperature were 2.0-3.2 mpy for aluminum alloy and 5.8 mpy for steel, which are higher than the USFS acceptable corrosion rates of 2.0 mpy. Compared to the corrosion rates of steel in Example 15, increase of the viscosity results in increase of corrosion for steel. Table 16B shows the detailed corrosion test results.

TABLE 16A
Diluted liquid fire retardant composition of Example 16

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Water | 78-93% |
| Total weight of fire retardant composition | 100% |

TABLE 16B
90-day corrosion testing results of Example 16

| Metal | Testing conditions | Corrosion rate/mpy |
|---|---|---|
| 2024 T3 aluminum | RTT | 0.4 |
| | RTP | 0.4 |
| | ETT | 2.8 |
| | ETP | 1.4 |
| 4130 steel | RTT | 0.0 |
| | RTP | 0.0 |
| | ETT | 5.8 |
| | ETP | 0.0 |
| Yellow brass | ETP | 0.2 |

### Example 17

The following example details a formulation and corrosion testing for a composition including a molybdate corrosion inhibitor (at a relatively high concentration) along with citric acid as a corrosion inhibitor as described in Example 2 above. With citric acid as a pH adjustor, molybdate at a higher concentration may be used as corrosion inhibitor to prepare a potassium carbonate based liquid fire retardant composition with pH value lower than 10. The detailed formula composition is shown in Table 17A. The physical characteristics of an as-prepared medium viscosity formulation show pH of 9.98, specific gravity of 1.092 g/ml, refractive index of 11.6 and viscosity of 600 cP. The 90-day corrosion test of the as-prepared formulation resulted in corrosion rates of less than 5 mpy for brass and steel, meeting the requirements of USFS acceptable corrosion rates. The corrosion rates were 1.5-3.1 mpy for aluminum alloy, which are higher than the USFS acceptable corrosion rates of 2.0 mpy. Table 17B shows the detailed corrosion test results.

TABLE 17A
Diluted liquid fire retardant composition of Example 17

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 1.5-3.0% |
| Citric acid pH adjustor | 2.0-3.0% |
| Water | 78-93% |
| Total weight of fire retardant composition | 100% |

TABLE 17B
90-day corrosion testing results of Example 17

| Metal | Testing conditions | Corrosion rate/mpy |
|---|---|---|
| 2024 T3 aluminum | RTT | 3.1 |
| | RTP | 2.0 |
| | ETT | 3.6 |
| | ETP | 1.5 |
| 4130 steel | RTT | 0.0 |
| | RTP | 0.0 |
| | ETT | 2.2 |
| | ETP | 0.0 |
| Yellow brass | ETP | 0.2 |

### Example 18

The following example details use of monosodium phosphate corrosion inhibitor along with citric acid like the formulation described above in Example 8 along with corrosion testing. With citric acid as the pH adjustor, a phosphate salt may be used as a corrosion inhibitor to prepare a potassium carbonate based liquid fire retardant composition. The physical characteristics of an as-prepared medium viscosity formulation show pH of 9.75, specific gravity of 1.092 g/ml, refractive index of 12.3 and viscosity of 590 cP. The detailed formula is shown in Table 18A. The 90-day corrosion test of the as-prepared formulation resulted in corrosion rates of less than 5 mpy for brass and steel, meeting the requirements of USFS acceptable corrosion rates. The corrosion rates were 10.4-133.9 mpy for aluminum alloy, which are higher than the USFS acceptable corrosion rates of 2.0 mpy. Table 18B shows the detailed corrosion test results.

TABLE 18A
Diluted liquid fire retardant composition of Example 18

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Monosodium phosphate corrosion inhibitor | 0.1-1.0% |
| Water | 77-92% |
| Total weight of fire retardant composition | 100% |

TABLE 18B
90-day corrosion testing results of Example 18

| Metal | Testing conditions | Corrosion rate/mpy |
|---|---|---|
| 2024 T3 aluminum | RTT | 16.7 |
| | RTP | 10.4 |
| | ETT | 133.9 |
| | ETP | 54.3 |
| 4130 steel | RTT | 0.0 |
| | RTP | 0.0 |
| | ETT | 2.6 |
| | ETP | 0.0 |
| Yellow brass | ETP | 0.2 |

### Example 19

The following example describes a formulation including calcium nitrate as a corrosion inhibitor along with citric acid as described in Example 4 along with corrosion testing. With citric acid as a pH adjustor, a soluble calcium compound (calcium nitrate) may be used as a corrosion inhibitor for preparing a potassium carbonate based liquid fire retardant composition. The detailed formula is listed in Table 19A. The physical characteristics of an as-prepared medium viscosity formulation show pH of 9.92, specific gravity of 1.089 g/ml, refractive index of 11.3 and viscosity of 600 cP. The 90-day corrosion test of the as-prepared formulation resulted in corrosion rates of less than 5.0 mpy for brass and steel, meeting the requirements of USFS acceptable corrosion rates. The corrosion rates for aluminum were 0.5-1.9 mpy, which are lower than the USFS acceptable corrosion rates of 2.0 mpy. The corrosion results show that it is an effective method of reducing corrosion of fire-retardant formulations by combining pH adjustor and soluble calcium compound. Table 19B shows the detailed corrosion test results.

TABLE 19A
Diluted liquid fire retardant composition of Example 19

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Calcium nitrate corrosion inhibitor | 0.2-1.0% |
| Water | 77-92% |
| Total weight of fire retardant composition | 100% |

TABLE 19B
90-day corrosion testing results of Example 19

| Metal | Testing conditions | Corrosion rate/mpy |
|---|---|---|
| 2024 T3 aluminum | RTT | 0.5 |
| | RTP | 0.7 |
| | ETT | 1.9 |
| | ETP | 1.2 |
| 4130 steel | RTT | 1.7 |
| | RTP | 1.7 |
| | ETT | 4.8 |
| | ETP | 0.0 |
| Yellow brass | ETP | 0.1 |

### Example 20

Along with citric acid as a pH adjustor, a soluble magnesium compound (magnesium sulfate) may be incorporated as a corrosion inhibitor for preparing a potassium carbonate based liquid fire retardant composition. The detailed formula is listed in Table 20A. The physical characteristics of an as-prepared medium viscosity formulation show pH of 9.84, specific gravity of 1.09 g/ml, refractive index of 12.4 and viscosity of 580 cP. The 90-day corrosion test of an as-prepared formulation resulted in corrosion rates of less than 5.0 mpy for brass and steel, meeting the requirements of USFS acceptable corrosion rates. The corrosion rates for aluminum tested at room temperatures were from 3.2 to 7.8 mpy, which are higher than the USFS acceptable corrosion rates of 2.0 mpy. Table 20B shows the detailed corrosion test results.

TABLE 20A
Diluted liquid fire retardant composition of Example 20

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Magnesium sulfate corrosion inhibitor | 0.5-2.0% |
| Water | 77-92% |
| Total weight of fire retardant composition | 100% |

TABLE 20B
90-day corrosion testing results of Example 20

| Metal | Testing conditions | Corrosion rate/mpy |
|---|---|---|
| 2024 T3 aluminum | RTT | 7.8 |
| | RTP | 3.2 |
| | ETT | 0.2 |
| | ETP | 0.1 |
| 4130 steel | RTT | 0.6 |
| | RTP | 2.6 |
| | ETT | 1.8 |
| | ETP | 1.9 |
| Yellow brass | ETP | 0.1 |

### Example 21

Along with citric acid as a pH adjustor, a fatty acid (e.g., lauric acid) may be incorporated as a corrosion inhibitor for preparing a potassium carbonate based liquid fire retardant composition. The detailed formula is listed in Table 21A. The physical characteristics of as-prepared medium viscosity formulation show pH of 9.94, specific gravity of 1.088 g/ml, refractive index of 11.6 and viscosity of 600 cP. The 90-day corrosion test of the as-prepared formulation resulted in corrosion rates of less than 5.0 mpy for brass and steel, meeting the requirements of USFS acceptable corrosion rates. The corrosion rates for aluminum were from 0.5 to 1.4 mpy, which are lower than the USFS acceptable corrosion rates of 2.0 mpy. The corrosion results show that it is an effective method of reducing corrosion of fire-retardant formulations by combining pH adjustor and a fatty acid. Table 21B shows the detailed corrosion test results.

TABLE 21A
Diluted liquid fire retardant composition of Example 7

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Lauric acid corrosion inhibitor | 0.2-1.0% |
| Water | 77-92% |
| Total weight of fire retardant composition | 100% |

TABLE 21B
90-day corrosion testing results of Example 21

| Metal | Testing conditions | Corrosion rate/mpy |
|---|---|---|
| 2024 T3 aluminum | RTT | 0.1 |
| | RTP | 0.2 |
| | ETT | 1.4 |
| | ETP | 1.0 |
| 4130 steel | RTT | 0.7 |
| | RTP | 1.5 |
| | ETT | 2.2 |
| | ETP | 2.6 |
| Yellow brass | ETP | 0.1 |

### Example 22

Along with citric acid as a pH adjustor, a salt of fatty acid (e.g., sodium stearate) may be incorporated as corrosion inhibitor for preparing a potassium carbonate based liquid fire retardant composition. The detailed formula is listed in Table 22A. The physical characteristics of as-prepared medium viscosity formulation show pH of 9.95, specific gravity of 1.09 g/ml, refractive index of 11.6 and viscosity of 680 cP. The 90-day corrosion test of the as-prepared formulation resulted in corrosion rates of from 1.0 to 11.8 for steel. The corrosion rates for aluminum tested at elevated temperatures were from 2.2 to 2.3 mpy, which are higher than the USFS acceptable corrosion rates of 2.0 mpy. Table 22B shows the detailed corrosion test results.

TABLE 22A
Diluted liquid fire retardant composition of Example 8

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Sodium stearate corrosion inhibitor | 0.2-1.0% |
| Water | 77-92% |
| Total weight of fire retardant composition | 100% |

TABLE 22B
90-day corrosion testing results of Example 8

| Metal | Testing conditions | Corrosion rate/mpy |
|---|---|---|
| 2024 T3 aluminum | RTT | 0.2 |
| | RTP | 0.2 |
| | ETT | 2.2 |
| | ETP | 2.3 |
| 4130 steel | RTT | 1.0 |
| | RTP | 5.1 |
| | ETT | 1.6 |
| | ETP | 11.8 |
| Yellow brass | ETP | 0.1 |

### Example 23

Along with citric acid as a pH adjustor, an aromatic carboxylate (e.g., sodium benzoate) may be utilized as a corrosion inhibitor for preparing a potassium carbonate based liquid fire retardant composition. The detailed formula is listed in Table 23A. The physical characteristics of an as-prepared medium viscosity formulation show pH of 9.94, specific gravity of 1.09 g/ml, refractive index of 12.2 and viscosity of 600 cP. The 90-day corrosion test of the as-prepared formulation resulted in corrosion rates of from 0.9 to 13.6 for steel. The corrosion rates for aluminum tested at elevated temperatures were from 1.9 to 9.7 mpy, which are higher than the USFS acceptable corrosion rates of 2.0 mpy. Table 23B shows the detailed corrosion test results.

TABLE 23A
Diluted liquid fire retardant composition of Example 23

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Sodium benzoate corrosion inhibitor | 0.2-1.0% |
| Water | 77-92% |
| Total weight of fire retardant composition | 100% |

TABLE 23B
90-day corrosion testing results of Example 23

| Metal | Testing conditions | Corrosion rate/mpy |
|---|---|---|
| 2024 T3 aluminum | RTT | 9.7 |
| | RTP | 1.8 |
| | ETT | 3.1 |
| | ETP | 1.9 |
| 4130 steel | RTT | 0.9 |
| | RTP | 4.8 |
| | ETT | 3.0 |
| | ETP | 13.6 |
| Yellow brass | ETP | 0.1 |

### Example 24

Along with citric acid as a pH adjustor, other aromatic carboxylates (e.g., sodium salicylate) may be utilized as a corrosion inhibitor for preparing a potassium carbonate based liquid fire retardant composition. The detailed formula is listed in Table 24A. The physical characteristics of an as-prepared medium viscosity formulation show pH of 9.93, specific gravity of 1.086 g/ml, refractive index of 11.8 and viscosity of 520 cP. The 90-day corrosion test of the as-prepared formulation resulted in corrosion rates of lower than 5 mpy for both steel and brass, meeting the requirements of USFS acceptable corrosion rates. The corrosion rates for aluminum tested at elevated temperatures were from 2.2 to 6.3 mpy, which are higher than the USFS acceptable corrosion rates of 2.0 mpy. Table 24B shows the detailed corrosion test results.

TABLE 24A
Diluted liquid fire retardant composition of Example 24

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Sodium salicylate corrosion inhibitor | 0.2-1.0% |
| Water | 77-92% |
| Total weight of fire retardant composition | 100% |

TABLE 24B
90-day corrosion testing results of Example 24

| Metal | Testing conditions | Corrosion rate/mpy |
|---|---|---|
| 2024 T3 aluminum | RTT | 0.3 |
| | RTP | 0.6 |
| | ETT | 6.3 |
| | ETP | 2.2 |
| 4130 steel | RTT | 0.4 |
| | RTP | 1.9 |
| | ETT | 1.4 |
| | ETP | 0.9 |
| Yellow brass | ETP | 0.1 |

### Example 25

Along with citric acid as a pH adjustor, a surfactant (e.g., sodium dodecylbenzene sulfonate) may be utilized as corrosion inhibitor for preparing a potassium carbonate based liquid fire retardant composition. The detailed formula is listed in Table 25A. The physical characteristics of an as-prepared medium viscosity formulation show pH of 9.99, specific gravity of 1.085 g/ml, refractive index of 11.8 and viscosity of 600 cP. The 90-day corrosion test of an as-prepared formulation resulted in corrosion rates of lower than 5 mpy for both steel and brass, meeting the requirements of USFS acceptable corrosion rates. The corrosion rates for aluminum tested at elevated temperatures were 1.6-4.6 mpy, which are higher than the USFS acceptable corrosion rates of 2.0 mpy. Table 25B shows the detailed corrosion test results.

TABLE 25A
Diluted liquid fire retardant composition of Example 25

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Sodium dodecylbenzene sulfonate corrosion | 0.2-1.0% |
| inhibitor | |
| Water | 77-92% |
| Total weight of fire retardant composition | 100% |

TABLE 25B
90-day corrosion testing results of Example 25

| Metal | Testing conditions | Corrosion rate/mpy |
|---|---|---|
| 2024 T3 aluminum | RTT | 0.6 |
| | RTP | 1.9 |
| | ETT | 4.6 |
| | ETP | 1.6 |
| 4130 steel | RTT | 0.4 |
| | RTP | 0.0 |
| | ETT | 2.3 |
| | ETP | 0.0 |
| Yellow brass | ETP | 0.4 |

### Example 26

Along with citric acid as a pH adjustor, an organic absorbent (e.g., polyethylene glycol) may be incorporated as corrosion inhibitor for preparing a potassium carbonate based liquid fire retardant composition. The detailed formula is listed in Table 26A. The physical characteristics of an as-prepared medium viscosity formulation show pH of 9.97, specific gravity of 1.08 g/ml, refractive index of 11.9 and viscosity of 600 cP. The 90-day corrosion test of an as-prepared formulation resulted in corrosion rates of lower than 5 mpy for both steel and brass, meeting the requirements of USFS acceptable corrosion rates. The corrosion rates for aluminum tested at elevated temperatures were 3.8-8.0 mpy, which are higher than the USFS acceptable corrosion rates of 2.0 mpy. Table 26B shows the detailed corrosion test results.

TABLE 26A
Diluted liquid fire retardant composition of Example 26

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Citric acid pH adjustor | 2.0-3.0% |
| Polyethylene glycol corrosion inhibitor | 0.2-1.0% |
| Water | 77-92% |
| Total weight of fire retardant composition | 100% |

TABLE 26B
90-day corrosion testing results of Example 26

| Metal | Testing conditions | Corrosion rate/mpy |
|---|---|---|
| 2024 T3 aluminum | RTT | 0.7 |
| | RTP | 0.9 |
| | ETT | 8.0 |
| | ETP | 3.8 |
| 4130 steel | RTT | 0.5 |
| | RTP | 0.0 |
| | ETT | 3.0 |
| | ETP | 0.0 |
| Yellow brass | ETP | 0.2 |

### Example 27

Along with sodium dihydrogen phosphate as a pH adjustor, a divalent compound (e.g., magnesium sulfate) may be incorporated as a corrosion inhibitor for preparing a potassium carbonate based liquid fire retardant composition. The detailed formula is listed in Table 27A. The physical characteristics of as prepared medium viscosity formulation show pH of 9.99, specific gravity of 1.098 g/ml, refractive index of 11.7 and viscosity of 660 cP. The 90-day corrosion test of the as-prepared formulation resulted in corrosion rates of lower than 5 mpy for both steel and brass, meeting the requirements of USFS acceptable corrosion rates. The corrosion rates for aluminum tested at elevated temperatures were 2.9 mpy, which is higher than the USFS acceptable corrosion rates of 2.0 mpy. Table 27B shows the detailed corrosion test results.

TABLE 27A
Diluted liquid fire retardant composition of Example 27

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Sodium dihydrogen phosphate pH adjustor | 2.0-3.0% |
| Magnesium sulfate corrosion inhibitor | 0.2-2.0% |
| Water | 77-92% |
| Total weight of fire retardant composition | 100% |

TABLE 27B
90-day corrosion testing results of Example 27

| Metal | Testing conditions | Corrosion rate/mpy |
|---|---|---|
| 2024 T3 aluminum | RTT | 0.2 |
| | RTP | 0.1 |
| | ETT | 0.1 |
| | ETP | 2.9 |
| 4130 steel | RTT | 0.0 |
| | RTP | 0.0 |
| | ETT | 0.7 |
| | ETP | 0.1 |
| Yellow brass | ETP | 0.1 |

### Example 28

A long with sodium dihydrogen phosphate as a pH adjustor, a carboxylic acid (e.g., citric acid) may be utilized as a corrosion inhibitor for preparing a potassium carbonate based liquid fire retardant composition. The detailed formula is listed in Table 28A. The physical characteristics of an as-prepared medium viscosity formulation show pH of 9.91, specific gravity of 1.099 g/ml, refractive index of 13.2 and viscosity of 600 cP. The 90-day corrosion test of the as-prepared formulation resulted in corrosion rates of lower than 5 mpy for both steel and brass, meeting the requirements of USFS acceptable corrosion rates. The corrosion rates for aluminum were 10.4-25.2 mpy, which are higher than the USFS acceptable corrosion rates of 2.0 mpy. Table 28B shows the detailed corrosion test results.

TABLE 28A
Diluted liquid fire retardant composition of Example 28

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Sodium dihydrogen phosphate pH adjustor | 2.0-3.0% |
| Citric acid corrosion inhibitor | 0.2-2.0% |
| Water | 77-92% |
| Total weight of fire retardant composition | 100% |

TABLE 28B
90-day corrosion testing results of Example 28

| Metal | Testing conditions | Corrosion rate/mpy |
|---|---|---|
| 2024 T3 aluminum | RTT | 19.3 |
| | RTP | 10.4 |
| | ETT | 25.2 |
| | ETP | 16.1 |
| 4130 steel | RTT | 0.0 |
| | RTP | 0.2 |
| | ETT | 0.8 |
| | ETP | 0.0 |
| Yellow brass | ETP | 0.2 |

### Example 29

Ammonium dihydrogen phosphate may be utilized as a pH adjustor for preparing a potassium carbonate based liquid fire retardant composition. The detailed formula is listed in Table 29A. The physical characteristics of an as-prepared low viscosity formulation show pH of 9.99, specific gravity of 1.1 g/ml, refractive index of 11.7 and viscosity of 340 cP. The 90-day corrosion test of the as-prepared formulation resulted in corrosion rates of lower than 5 mpy for both steel and brass, meeting the requirements of USFS acceptable corrosion rates. The corrosion rates for aluminum were 3.9 mpy, which is higher than the USFS acceptable corrosion rates of 2.0 mpy. Table 29B shows the detailed corrosion test results.

TABLE 29A
Diluted liquid fire retardant composition of Example 29

| | Weight percentage |
|---|---|
| | in fire retardant |
| Ingredient | composition |
| Potassium carbonate | 5-15% |
| Biopolymer thickener | 0.1-0.5% |
| Fugitive pigment | 0.1-0.5% |
| Opacifier | 0.01-0.05% |
| Flow conditioner | 0.05-0.5% |
| Tolytriazole corrosion inhibitor | 0.01-0.05% |
| Molybdate corrosion inhibitor | 0.01-0.05% |
| Ammonium dihydrogen phosphate pH adjustor | 2.0-3.0% |
| Water | 77-92% |
| Total weight of fire retardant composition | 100% |

TABLE 29B
90-day corrosion testing results of Example 29

| Metal | Testing conditions | Corrosion rate/mpy |
|---|---|---|
| 2024 T3 aluminum | RTT | 0.5 |
| | RTP | 1.0 |
| | ETT | 0.6 |
| | ETP | 3.9 |
| 4130 steel | RTT | 0.0 |
| | RTP | 0.0 |
| | ETT | 0.9 |
| | ETP | 0.0 |
| Yellow brass | ETP | 1.1 |

### EMBODIMENTS

For additional illustration, further and preferred embodiments of the present invention are set forth below.

Embodiment 1 is directed to a fire retardant composition, the composition comprising: at least one fire retardant comprising at least one carbonate salt, wherein the at least one carbonate salt is selected from the group consisting of metal salts, ammonium salts, guanidine salts, and combinations thereof; and a corrosion inhibitor for at least one of steel, aluminum, brass, and/or magnesium, wherein the corrosion inhibitor is a fatty acid selected from the group consisting of caprylic acid, palmic acid, lauric acid, myristic acid, palmitic acid, stearic acid, and combinations thereof.

Embodiment 2 is directed to a fire retardant composition, the composition comprising: at least one fire retardant comprising at least one carbonate salt, wherein the at least one carbonate salt is selected from the group consisting of metal salts, ammonium salts, guanidine salts, and combinations thereof; and a corrosion inhibitor for at least one of steel, aluminum, brass, and/or magnesium, wherein the corrosion inhibitor is an alkali metal salt of a fatty acid, wherein the alkali metal is selected from the group consisting of sodium, potassium, and combinations thereof (e.g., sodium or potassium caprylate, caprate, laurate, myristate, palate, stearate, and combinations thereof).

Embodiment 3 is directed to a fire retardant composition, the composition comprising: at least one fire retardant comprising at least one carbonate salt, wherein the at least one carbonate salt is selected from the group consisting of metal salts, ammonium salts, guanidine salts, and combinations thereof; and a corrosion inhibitor for at least one of steel, aluminum, brass, and/or magnesium, wherein the corrosion inhibitor comprises a water soluble divalent cation compound comprising anhydrous calcium hydroxide or a hydrate thereof.

Embodiment 4 is directed to a fire retardant composition, the composition comprising: at least one fire retardant comprising at least one carbonate salt, wherein the at least one carbonate salt is selected from the group consisting of metal salts, ammonium salts, guanidine salts, and combinations thereof; and a corrosion inhibitor for at least one of steel, aluminum, brass, and/or magnesium, wherein the corrosion inhibitor comprises a water soluble divalent cation compound comprising magnesium selected from the group consisting of magnesium chloride or a hydrate thereof, magnesium sulfate or a hydrate thereof, magnesium sulfite or a hydrate thereof, magnesium nitrate or a hydrate thereof, and combinations thereof.

Embodiment 5 is directed to a fire retardant composition, the composition comprising: at least one fire retardant comprising at least one carbonate salt, wherein the at least one carbonate salt is selected from the group consisting of metal salts, ammonium salts, guanidine salts, and combinations thereof; and a corrosion inhibitor for at least one of steel, aluminum, brass, and/or magnesium, wherein the corrosion inhibitor comprises a water soluble divalent cation compound comprising barium selected from the group consisting of barium chloride, barium nitrate and combinations thereof.

Embodiment 6 is directed to a fire retardant composition, the composition comprising: at least one fire retardant comprising at least one carbonate salt, wherein the at least one carbonate salt is selected from the group consisting of metal salts, ammonium salts, guanidine salts, and combinations thereof; and a corrosion inhibitor for at least one of steel, aluminum, brass, and/or magnesium, wherein the corrosion inhibitor comprises a phosphate compound selected from the group consisting of sodium dihydrogen phosphate, disodium hydrogen phosphate, trisodium phosphate, potassium dihydrogen phosphate, dipotassium hydrogen phosphate, tripotassium phosphate, monocalcium phosphate, and combinations thereof.

Embodiment 7 is directed to a fire retardant composition, the composition comprising: at least one fire retardant comprising at least one carbonate salt, wherein the at least one carbonate salt is selected from the group consisting of metal salts, ammonium salts, guanidine salts, and combinations thereof; and a corrosion inhibitor for at least one of steel, aluminum, brass, and/or magnesium, wherein the corrosion inhibitor comprises an organic chelating compound selected from the group consisting of ethylenediaminetraacetic acid (EDTA), ethyleneglycol bis(2-aminoethyl ether)-N,N,N′,N′ tetraacetic acid (EGTA), polyethylene glycol, glycerol, 4-(4-nitrophenylazo)-1-naphthol (44NIN), polyacrylic acids, 8-hydroxyquinoline, polymethacrylate, salicylaldoxime, 2-mercaptoenzothiazole, thioacetamide, quinaldic acid, alpha-benzoionoxime, 2-(2-hydroxyphenyl)benzoxazole, dithiooxamide, cuprizone, cupferron, 1,2,4-triazole, 3-amino-1,2,4-triazole, 2-mercaptobenzothiazole, and combinations thereof.

Embodiment 8 is directed to a fire retardant composition, the composition comprising: at least one fire retardant comprising at least one carbonate salt, wherein the at least one carbonate salt is selected from the group consisting of metal salts, ammonium salts, guanidine salts, and combinations thereof; and a corrosion inhibitor for at least one of steel, aluminum, brass, and/or magnesium, wherein the corrosion inhibitor comprises a surfactant selected from nonionic surfactants, anionic surfactants, and/or cationic surfactants selected from the group consisting of sodium N-lauroylsarcosine, N-lauroyl-N-methyltaurine, fatty alcohol ethoxylates, alky phenol ethoxylates, and sorbitan esters, C8-C10 alkyamidodimethyl propylamine, alkylimethyl amine oxides, cetyl trimethylammonium chloride, didecyldimethylammonium chloride, dodecyltrimethylammonium chloride, tetrabutylammonium chloride, tetramethylammonium fluoride tetrahydrate, benzyltriethylammonium chloride, hexadecyltrimethylammonium chloride, and combinations of thereof.

Embodiment 9 is a composition of any of Embodiments 1 to 8 wherein the composition further comprises a pH adjustor for regulating the pH value of the fire retardant composition within a range of from about 4 to about 10.

Embodiment 10 is directed to a fire retardant composition, the composition comprising: at least one fire retardant comprising at least one carbonate salt, wherein the at least one carbonate salt is selected from the group consisting of metal salts, ammonium salts, guanidine salts, and combinations thereof; a corrosion inhibitor for at least one of steel, aluminum, brass, and/or magnesium; and a pH adjustor for regulating the pH value of the fire retardant composition within a range of from about 4 to about 10, wherein: the pH adjustor is present in a concentration of from about 1 wt % to about 5 wt % (e.g., from about 1 wt % to about 4 wt %, from about 2 wt % to about 4 wt %, or from about 2 wt % to about 3 wt %); and the pH adjustor is selected from the group consisting of monocarboxylic acids, dicarboxylic acids, tricarboxylic acids, phosphate compounds, and combinations thereof.

Embodiment 11 is the composition of Embodiment 10 wherein the pH adjustor is selected from the group consisting of acetic acid, malic acid, oxalic acid, citric acid, and combinations thereof.

Embodiment 12 I the composition of Embodiment 10 wherein the pH adjustor comprises monoammonium phosphate (MAP), monosodium phosphate, or a combination thereof.

Embodiment 13 is the composition of any of Embodiments 10 to 12 wherein the pH adjustor is present in the composition in a weight ratio to the at least one carbonate salt of from about 0.05:1 to about 1:1, from about 0.1:1 to about 0.8:1, from about 0.1:1 to about 0.6:1, from about 0.15:1 to about 0.6:1, or from about 0.2:1 to about 0.4:1.

Embodiment 14 is a fire retardant composition, the composition comprising: at least one fire retardant comprising at least one carbonate salt, wherein the at least one carbonate salt is selected from the group consisting of metal salts, ammonium salts, guanidine salts, and combinations thereof; and a corrosion inhibitor for at least one of steel, aluminum, brass, and/or magnesium, wherein the one or more corrosion inhibitors comprise a fatty acid or a salt thereof, the fatty acid having an aliphatic chain of from 8 to 26 carbon atoms.

Embodiment 15 is the composition of Embodiment 14 wherein the fatty acid is selected from the group consisting of caprylic acid, palmic acid, lauric acid, myristic acid, palmitic acid, stearic acid, and combinations thereof.

Embodiment 16 is the composition of Embodiment 14 or 15 wherein the corrosion inhibitor comprises an alkali metal salt of a fatty acid, wherein the alkali metal is selected from the group consisting of sodium, potassium, lithium, cerium and combinations thereof.

Embodiment 17 is the composition of Embodiment 16 wherein the corrosion inhibitor comprises a sodium or potassium caprylate, caprate, laurate, myristate, palate, stearate, and combinations thereof.

Embodiment 18 is the composition of any of Embodiments 14 to 17 wherein the fatty acid or salt thereof is present in a concentration of from about 0.01 wt % to about 5.0 wt %, from about 0.1 wt % to about 4.0 wt %, from about 0.1 wt % to about 3.0 wt %, or from about 0. wt % to about 1.0% wt %.

Embodiment 19 is the composition of any of Embodiments 14 to 18 wherein the composition further comprises a pH adjustor for regulating the pH value of the fire retardant composition within a range of from about 4 to about 10, wherein: the pH adjustor is present in a concentration of from about 1 wt % to about 5 wt % (e.g., from about 1 wt % to about 4 wt %, from about 2 wt % to about 4 wt %, or from about 2 wt % to about 3 wt %); and/or the pH adjustor is selected from the group consisting of monocarboxylic acids, dicarboxylic acids, tricarboxylic acids, phosphate compounds, and combinations thereof.

Embodiment 20 is a fire retardant composition, the composition comprising: at least one fire retardant comprising at least one carbonate salt, wherein the at least one carbonate salt is selected from the group consisting of metal salts, ammonium salts, guanidine salts, and combinations thereof; a corrosion inhibitor for at least one of steel, aluminum, brass, and/or magnesium, wherein the one or more corrosion inhibitors comprise a water soluble divalent cation compound comprising a divalent cation selected from the group consisting of calcium, magnesium, or barium; and a pH adjustor for regulating the pH value of the fire retardant composition within a range of from about 4 to about 10, wherein: the pH adjustor is present in a concentration of from about 1 wt % to about 5 wt % (e.g., from about 1 wt % to about 4 wt %, from about 2 wt % to about 4 wt %, or from about 2 wt % to about 3 wt %); and/or the pH adjustor is selected from the group consisting of monocarboxylic acids, dicarboxylic acids, tricarboxylic acids, phosphate compounds, and combinations thereof.

Embodiment 21 is the composition of Embodiment 20 wherein the water soluble divalent cation compound comprises calcium, the divalent cation compound being selected from the group consisting of anhydrous calcium oxide or a hydrate thereof, anhydrous calcium hydroxide or a hydrate thereof, anhydrous calcium nitrate or a hydrate thereof, anhydrous calcium acetate or a hydrate thereof, anhydrous calcium chloride or a hydrate thereof, and combinations thereof.

Embodiment 22 is the composition of Embodiment 20 wherein the water soluble divalent cation compound comprises magnesium, the divalent cation compound being selected from the group consisting of magnesium chloride or a hydrate thereof, magnesium sulfate or a hydrate thereof, magnesium sulfite or a hydrate thereof, magnesium nitrate or a hydrate thereof, and combinations thereof.

Embodiment 23 is the composition of Embodiment 20 wherein the water soluble divalent cation compound comprises barium, the divalent cation compound being selected from the group consisting of barium chloride, barium nitrate and combinations thereof.

Embodiment 24 is the composition of any one of Embodiments 20 to 23 wherein the water-soluble divalent cation compound is present in a concentration of at least about 0.1 wt %, at least about 0.2 wt %, at least about 0.3 wt %, at least about 0.4 wt %, at least about 0.5 wt %, or at least about 0.6 wt %, and/or less than about 3 wt %, less than about 2.5 wt %, less than about 2 wt %, or less than about 1 wt %.

Embodiment 25 is a fire retardant composition, the composition comprising: at least one fire retardant comprising at least one carbonate salt, wherein the at least one carbonate salt is selected from the group consisting of metal salts, ammonium salts, guanidine salts, and combinations thereof; a corrosion inhibitor for at least one of steel, aluminum, brass, and/or magnesium, wherein the one or more corrosion inhibitors is an alkali metal phosphate selected from the group consisting of sodium dihydrogen phosphate, disodium hydrogen phosphate, trisodium phosphate, potassium dihydrogen phosphate, dipotassium hydrogen phosphate, tripotassium phosphate, monocalcium phosphate, and combinations thereof; and a pH adjustor for regulating the pH value of the fire retardant composition within a range of from about 4 to about 10, wherein: the pH adjustor is present in a concentration of from about 1 wt % to about 5 wt % (e.g., from about 1 wt % to about 4 wt %, from about 2 wt % to about 4 wt %, or from about 2 wt % to about 3 wt %); and/or the pH adjustor is selected from the group consisting of monocarboxylic acids, dicarboxylic acids, tricarboxylic acids, phosphate compounds, and combinations thereof.

Embodiment 26 is the composition of Embodiment 25 wherein the corrosion inhibitor comprises an alkali metal phosphate in its anhydrous form.

Embodiment 27 is the composition of Embodiment 25 or 26 wherein the alkali metal phosphate is present in a concentration of from about 0.1 wt % to about 3 wt %, from about 0.1 wt % to about 2 wt %, or from about 0.1 to about 1 wt %.

Embodiment 28 is a fire retardant composition, the composition comprising: at least one fire retardant comprising at least one carbonate salt, wherein the at least one carbonate salt is selected from the group consisting of metal salts, ammonium salts, guanidine salts, and combinations thereof; and a corrosion inhibitor for at least one of steel, aluminum, brass, and/or magnesium, wherein the corrosion inhibitor comprises an organic chelating compoundselected from the group consisting of ethylenediaminetraacetic acid (EDTA), ethyleneglycol Bis(2-aminoethyl ether)-N,N,N′,N′ tetraacetic acid (EGTA), polyethylene glycol, glycerol, 4-(4-nitrophenylazo)-1-naphthol (44NIN), polyacrylic acids, 8-hydroxyquinoline, polymethacrylate, salicylaldoxime, 2-mercaptoenzothiazole, thioacetamide, quinaldic acid, alpha-benzoionoxime, 2-(2-hydroxyphenyl)benzoxazole, dithiooxamide, cuprizone, cupferron, 2,5-dimercapto-1,3,4-thiadiazolate (DMTD), 1,2,4-triazole, 3-amino-1,2,4-triazole, benzotriazole, 2-mercaptobenzothiazole, tolyltriazole, and combinations thereof; and a pH adjustor for regulating the pH value of the fire retardant composition within a range of from about 4 to about 10, wherein: the pH adjustor is present in a concentration of from about 2 wt % to about 3 wt %; and/or the pH adjustor is selected from the group consisting of monocarboxylic acids, dicarboxylic acids, tricarboxylic acids, phosphate compounds, and combinations thereof.

Embodiment 29 is directed to a fire retardant composition, the composition comprising: at least one fire retardant comprising at least one carbonate salt, wherein the at least one carbonate salt is selected from the group consisting of metal salts, ammonium salts, guanidine salts, and combinations thereof; and a corrosion inhibitor for at least one of steel, aluminum, brass, and/or magnesium, wherein the corrosion inhibitor comprises an organic chelating compound selected from the group consisting of ethylenediaminetraacetic acid (EDTA), ethyleneglycol Bis(2-aminoethyl ether)-N,N,N′,N′ tetraacetic acid (EGTA), polyethylene glycol, glycerol, 4-(4-nitrophenylazo)-1-naphthol (44NIN), polyacrylic acids, 8-hydroxyquinoline, polymethacrylate, salicylaldoxime, 2-mercaptoenzothiazole, thioacetamide, quinaldic acid, alpha-benzoionoxime, 2-(2-hydroxyphenyl)benzoxazole, dithiooxamide, cuprizone, cupferron, 2,5-dimercapto-1,3,4-thiadiazolate (DMTD), and combinations thereof.

Embodiment 30 is directed to the composition of Embodiment 28 or 29 wherein the organic chelating compound is present in a concentration of from about 0.01 wt % to about 2.0 wt %, from about 0.1 wt % to about 2 wt %, from about 0.1 wt % to about 1.2 wt %, or from 0.1 wt % to about 1.0 wt %.

Embodiment 31 is a fire retardant composition, the composition comprising: at least one fire retardant comprising at least one carbonate salt, wherein the at least one carbonate salt is selected from the group consisting of metal salts, ammonium salts, guanidine salts, and combinations thereof; a corrosion inhibitor for at least one of steel, aluminum, brass, and/or magnesium, wherein the corrosion inhibitor comprises a surfactant selected from nonionic surfactants, anionic surfactants, or cationic surfactants; and a pH adjustor for regulating the pH value of the fire retardant composition within a range of from about 4 to about 10, wherein: the pH adjustor is present in a concentration of from about 1 wt % to about 5 wt % (e.g., from about 1 wt % to about 4 wt %, from about 2 wt % to about 4 wt %, or from about 2 wt % to about 3 wt %); and/or the pH adjustor is selected from the group consisting of monocarboxylic acids, dicarboxylic acids, tricarboxylic acids, phosphate compounds, and combinations thereof.

Embodiment 32 is the composition of Embodiment 31 wherein the surfactant is selected from the group consisting of sodium dodecyl sulfate, sodium dodecylbenzene sulfonate, sodium N-lauroylsarcosine, N-lauroyl-N-methyltaurine, fatty alcohol ethoxylates, alky phenol ethoxylates, and sorbitan esters, C8-C10 alkyamidodimethyl propylamine, alkylimethyl amine oxides, didecyldimethylammonium chloride, dodecyltrimethylammonium chloride, tetrabutylammonium chloride, tetramethylammonium fluoride tetrahydrate, benzyltriethylammonium chloride, hexadecyltrimethylammonium chloride, and combinations of thereof.

Embodiment 33 is the composition of Embodiment 31 or 32 wherein the surfactant is present in a concentration of from about 0.01 wt % to 0.5 wt %, from about 0.03 wt % to about 0.3 wt %, or from about 0.05 wt % to about 0.15 wt %.

Embodiment 34 is the composition of any of the preceding Embodiments, wherein the at least one carbonate salt comprises an alkali metal carbonate salt selected from the group consisting of potassium carbonate, potassium bicarbonate, sodium carbonate, sodium bicarbonate, lithium carbonate and combinations thereof.

Embodiment 35 is the composition of Embodiment 34 wherein the at least one carbonate salt is selected from the group consisting of potassium carbonate, potassium bicarbonate, and combinations thereof.

Embodiment 36 is the composition of Embodiment 34 or 35 wherein the at least one carbonate salt comprises an alkali metal carbonate salt selected from the group consisting of sodium carbonate, sodium bicarbonate, and combinations thereof.

Embodiment 37 is the composition of Embodiment 34 or 35 wherein the at least one carbonate salt comprises an ammonium carbonate salt selected from ammonium carbonate, ammonium bicarbonate, and combinations thereof.

Embodiment 38 is the composition of Embodiment 34 or 35 wherein the at least one carbonate salt comprises guanidine carbonate.

Embodiment 39 is the composition of Embodiment 34 or 35 wherein the at least one fire retardant comprises a carbonate selected from the group consisting of potassium carbonate, potassium bicarbonate, sodium carbonate, sodium bicarbonate, lithium carbonate, ammonium carbonate, ammonium bicarbonate, guanidine carbonate, and combinations thereof.

Embodiment 40 is the composition of any of the preceding Embodiments, wherein the composition is a liquid fire retardant concentrate, the concentrate comprising the at least one fire retardant in a concentration of from about 5 wt % to about 50 wt % relative to the total weight of composition, and the one or more corrosion inhibitors in a concentration of from about 0.05 wt % to about 50 wt % relative to the weight of the at least one fire retardant.

Embodiment 41 is the composition of any of the preceding Embodiments, wherein the composition is a dry fire retardant concentrate, the concentrate comprising the at least one fire retardant in a concentration of from about 5 wt % to about 100 wt %, and the one or more corrosion inhibitors in a concentration of from about 0.05 wt % to about 50 wt % relative to the weight of the at least one fire retardant.

Embodiment 42 is the composition of any of Embodiments 10 to 39, wherein the composition is a fire retardant solution, the solution comprising the at least one fire retardant in a concentration of from about 5 wt % to about 25 wt %, and the one or more corrosion inhibitors present in a weight percentage of from about 0.05 wt % to about 50 wt % relative to the weight of the at least one fire retardant.

Embodiment 43 is a fire retardant composition, the composition comprising: at least one fire retardant, wherein the at least one fire retardant comprises potassium carbonate or potassium bicarbonate; a corrosion inhibitor for at least one of steel, aluminum, brass, and/or magnesium; and a pH adjustor for regulating the pH value of the fire retardant below 10, wherein the pH adjustor comprises citric acid, wherein the corrosion inhibitor is selected from: molybdate corrosion inhibitors, azole corrosion inhibitors, phosphate compounds, calcium compounds, magnesium compounds, fatty acids and salts thereof, and aromatic carboxylate corrosion inhibitors, and combinations thereof.

Embodiment 44 is the composition of Embodiment 43 wherein the corrosion inhibitor is present in a concentration of at least about 0.1 wt %, at least about 0.2 wt %, at least about 0.3 wt %, at least about 0.4 wt %, at least about 0.5 wt %, from about 0.1 wt % to about 2.0 wt %, from about 0.1 wt % to about 1.5 wt %, or from about 0.2 wt % to about 1.0 wt %.

Embodiment 45 is the composition of Embodiment 43 or 44 wherein the corrosion inhibitor comprises monosodium phosphate, sodium dihydrogen phosphate, disodium hydrogen phosphate, trisodium phosphate, potassium dihydrogen phosphate, dipotassium hydrogen phosphate, tripotassium phosphate, monocalcium phosphate, or a combination thereof.

Embodiment 46 is the composition of any one of Embodiments 43 to 45 wherein the corrosion inhibitor comprises a calcium compound selected from the group consisting of anhydrous calcium oxide or a hydrate thereof, anhydrous calcium hydroxide or a hydrate thereof, anhydrous calcium nitrate or a hydrate thereof, anhydrous calcium acetate or a hydrate thereof, anhydrous calcium chloride or a hydrate thereof, and combinations thereof.

Embodiment 47 is the composition of any of Embodiments 43 to 46 wherein the corrosion inhibitor comprises magnesium chloride or a hydrate thereof, magnesium sulfate or a hydrate thereof, magnesium sulfite or a hydrate thereof, magnesium nitrate or a hydrate thereof, and combinations thereof.

Embodiment 48 is the composition of any one of Embodiments 43 to 47 wherein the corrosion inhibitor comprises a fatty acid compound or salt thereof selected from the group consisting of caprylic acid, palmic acid, lauric acid, myristic acid, palmitic acid, stearic acid, and combinations thereof, and alkali metal salts thereof.

Embodiment 49 is the composition of any one of Embodiments 43 to 48 wherein the corrosion inhibitor comprises an aromatic carboxylate corrosion inhibitor selected from sodium benzoate, sodium salicylate, and combinations thereof.

Embodiment 50 is the composition of any one of Embodiments 43 to 49 wherein the composition has a viscosity (when measured in accordance with Specification 5100-304d, January 2020, including any and all amendments) of less than about 1000 centipoise (cP), less than about 900 cP, less than about 800 cP, less than about 700 cP, less than about 600 cP, less than about 500 cP, less than about 400 cP, from about 200 cP to about 800 cP, or from about 400 cP to about 600 cP.

Embodiment 51 is the composition of any one of Embodiments 43 to 50 wherein the composition has a pH of less than about 9.8, less than 9.8, less than about 9.6, or less than 9.6.

Embodiment 52 is the composition of any one of Embodiments 43 to 51 wherein the citric acid pH adjustor compound is present in a concentration of at least about 0.5 wt %, at least about 1.0 wt %, at least about 1.5 wt %, at least about 2.0 wt %, from about 0.5 wt % to about 4.0 wt %, from about 1.0 wt % to about 3.0 wt %, or from about 1.0 to about 2.0 wt %.

Embodiment 53 is the composition of any one of Embodiments 43 to 52 wherein the composition meets at least one of the metal corrosion standards established in USFS Specification 5100-304d (Jan. 7, 2020), entitled “Long-Term Retardant, Wildland Firefighting.”

What is claimed is:

1. A fire retardant composition, the composition comprising:
at least one fire retardant comprising at least one carbonate salt, wherein the at least one carbonate salt is selected from the group consisting of metal salts, ammonium salts, guanidine salts, and combinations thereof;
a corrosion inhibitor for at least one of steel, aluminum, brass, and/or magnesium; and
a pH adjustor for regulating the pH value of the fire retardant composition within a range of from about 4 to about 10, wherein:
the pH adjustor is present in a concentration of from about 1 wt % to about 5 wt %; and
the pH adjustor is selected from the group consisting of monocarboxylic acids, dicarboxylic acids, tricarboxylic acids, phosphate compounds, and combinations thereof.

2. The composition of claim 1 wherein the pH adjustor is selected from the group consisting of acetic acid, malic acid, oxalic acid, citric acid, and combinations thereof; or the pH adjustor comprises monoammonium phosphate (MAP), monosodium phosphate, or a combination thereof; and
the pH adjustor is present in the composition in a weight ratio to the at least one carbonate salt of from about 0.05:1 to about 1:1.

3. (canceled)

4. (canceled)

5. A fire retardant composition, the composition comprising:
at least one fire retardant comprising at least one carbonate salt, wherein the at least one carbonate salt is selected from the group consisting of metal salts, ammonium salts, guanidine salts, and combinations thereof; and
a corrosion inhibitor for at least one of steel, aluminum, brass, and/or magnesium, wherein the one or more corrosion inhibitors comprise a fatty acid or a salt thereof, the fatty acid having an aliphatic chain of from 8 to 26 carbon atoms.

6. The composition of claim 5 wherein the fatty acid is selected from the group consisting of caprylic acid, palmic acid, lauric acid, myristic acid, palmitic acid, stearic acid, and combinations thereof.

7. (canceled)

8. (canceled)

9. (canceled)

10. The composition of claim 6 wherein the composition further comprises a pH adjustor for regulating the pH value of the fire retardant composition within a range of from about 4 to about 10, wherein:
the pH adjustor is present in a concentration of from about 1 wt % to about 5 wt %; and/or
the pH adjustor is selected from the group consisting of monocarboxylic acids, dicarboxylic acids, tricarboxylic acids, phosphate compounds, and combinations thereof.

11. The fire retardant composition of claim 1,
wherein the one or more corrosion inhibitors comprise a water soluble divalent cation compound comprising a divalent cation selected from the group consisting of calcium, magnesium, or barium.

12. The composition of claim 11 wherein the water soluble divalent cation compound comprises calcium, the divalent cation compound being selected from the group consisting of anhydrous calcium oxide or a hydrate thereof, anhydrous calcium hydroxide or a hydrate thereof, anhydrous calcium nitrate or a hydrate thereof, anhydrous calcium acetate or a hydrate thereof, anhydrous calcium chloride or a hydrate thereof, and combinations thereof; or
wherein the water soluble divalent cation compound comprises magnesium, the divalent cation compound being selected from the group consisting of magnesium chloride or a hydrate thereof, magnesium sulfate or a hydrate thereof, magnesium sulfite or a hydrate thereof, magnesium nitrate or a hydrate thereof, and combinations thereof; or
wherein the water soluble divalent cation compound comprises barium, the divalent cation compound being selected from the group consisting of barium chloride, barium nitrate and combinations thereof.

13. (canceled)

14. (canceled)

15. (canceled)

16. The fire retardant composition of claim 1,
wherein the one or more corrosion inhibitors is an alkali metal phosphate selected from the group consisting of sodium dihydrogen phosphate, disodium hydrogen phosphate, trisodium phosphate, potassium dihydrogen phosphate, dipotassium hydrogen phosphate, tripotassium phosphate, monocalcium phosphate, and combinations thereof.

17. (canceled)

18. (canceled)

19. The fire retardant composition of claim 1,
wherein the corrosion inhibitor comprises an organic chelating compoundselected from the group consisting of ethylenediaminetraacetic acid (EDTA), ethyleneglycol Bis(2-aminoethyl ether)-N,N,N′,N′ tetraacetic acid (EGTA), polyethylene glycol, glycerol, 4-(4-nitrophenylazo)-1-naphthol (44NIN), polyacrylic acids, 8-hydroxyquinoline, polymethacrylate, salicylaldoxime, 2-mercaptoenzothiazole, thioacetamide, quinaldic acid, alpha-benzoionoxime, 2-(2-hydroxyphenyl)benzoxazole, dithiooxamide, cuprizone, cupferron, 2,5-dimercapto-1,3,4-thiadiazolate (DMTD), 1,2,4-triazole, 3-amino-1,2,4-triazole, benzotriazole, 2-mercaptobenzothiazole, tolyltriazole, and combinations thereof.

20. A fire retardant composition, the composition comprising:
at least one fire retardant comprising at least one carbonate salt, wherein the at least one carbonate salt is selected from the group consisting of metal salts, ammonium salts, guanidine salts, and combinations thereof; and
a corrosion inhibitor for at least one of steel, aluminum, brass, and/or magnesium, wherein the corrosion inhibitor comprises an organic chelating compound selected from the group consisting of ethylenediaminetraacetic acid (EDTA), ethyleneglycol Bis(2-aminoethyl ether)-N,N,N′,N′ tetraacetic acid (EGTA), polyethylene glycol, glycerol, 4-(4-nitrophenylazo)-1-naphthol (44NIN), polyacrylic acids, 8-hydroxyquinoline, polymethacrylate, salicylaldoxime, 2-mercaptoenzothiazole, thioacetamide, quinaldic acid, alpha-benzoionoxime, 2-(2-hydroxyphenyl)benzoxazole, dithiooxamide, cuprizone, cupferron, 2,5-dimercapto-1,3,4-thiadiazolate (DMTD), and combinations thereof.

21. (canceled)

22. The fire retardant composition of claim 1,
wherein the corrosion inhibitor comprises a surfactant selected from nonionic surfactants, anionic surfactants, cationic surfactants, and combinations thereof.

23. The composition of claim 22 wherein the surfactant is selected from the group consisting of sodium dodecyl sulfate, sodium dodecylbenzene sulfonate, sodium N-lauroylsarcosine, N-lauroyl-N-methyltaurine, fatty alcohol ethoxylates, alky phenol ethoxylates, and sorbitan esters, C8-C10 alkyamidodimethyl propylamine, alkylimethyl amine oxides, didecyldimethylammonium chloride, dodecyltrimethylammonium chloride, tetrabutylammonium chloride, tetramethylammonium fluoride tetrahydrate, benzyltriethylammonium chloride, hexadecyltrimethylammonium chloride, and combinations of thereof.

24. (canceled)

25. (canceled)

26. (canceled)

27. (canceled)

28. (canceled)

29. (canceled)

30. (canceled)

31. The composition of claim 1, wherein the composition is a liquid fire retardant concentrate, the concentrate comprising the at least one fire retardant in a concentration of from about 5 wt % to about 50 wt % relative to the total weight of composition, and the one or more corrosion inhibitors in a concentration of from about 0.05 wt % to about 50 wt % relative to the weight of the at least one fire retardant.

32. The composition of claim 1, wherein the composition is a dry fire retardant concentrate, the concentrate comprising the at least one fire retardant in a concentration of from about 5 wt % to about 100 wt %, and the one or more corrosion inhibitors in a concentration of from about 0.05 wt % to about 50 wt % relative to the weight of the at least one fire retardant.

33. The composition of claim 1, wherein the composition is a fire retardant solution, the solution comprising the at least one fire retardant in a concentration of from about 5 wt % to about 25 wt %, and the one or more corrosion inhibitors present in a weight percentage of from about 0.05 wt % to about 50 wt % relative to the weight of the at least one fire retardant.

34. A fire retardant composition, the composition comprising:
at least one fire retardant, wherein the at least one fire retardant comprises potassium carbonate or potassium bicarbonate;
a corrosion inhibitor for at least one of steel, aluminum, brass, and/or magnesium; and
a pH adjustor for regulating the pH value of the fire retardant below 10, wherein the pH adjustor comprises citric acid, wherein the corrosion inhibitor is selected from:
molybdate corrosion inhibitors, azole corrosion inhibitors, phosphate compounds, calcium compounds, magnesium compounds, fatty acids and salts thereof, and aromatic carboxylate corrosion inhibitors, and combinations thereof.

35. The composition of claim 34 wherein the corrosion inhibitor is present in a concentration of from about 0.1 wt % to about 2.0 wt %, from about 0.1 wt % to about 1.5 wt %, or from about 0.2 wt % to about 1.0 wt %.

36. The composition of claim 34 wherein the corrosion inhibitor comprises monosodium phosphate, sodium dihydrogen phosphate, disodium hydrogen phosphate, trisodium phosphate, potassium dihydrogen phosphate, dipotassium hydrogen phosphate, tripotassium phosphate, monocalcium phosphate, or a combination thereof.

37. The composition of claim 34 wherein the corrosion inhibitor comprises a calcium compound selected from the group consisting of anhydrous calcium oxide or a hydrate thereof, anhydrous calcium hydroxide or a hydrate thereof, anhydrous calcium nitrate or a hydrate thereof, anhydrous calcium acetate or a hydrate thereof, anhydrous calcium chloride or a hydrate thereof, and combinations thereof.

38. The composition of claim 34 wherein the corrosion inhibitor comprises magnesium chloride or a hydrate thereof, magnesium sulfate or a hydrate thereof, magnesium sulfite or a hydrate thereof, magnesium nitrate or a hydrate thereof, and combinations thereof; or
the corrosion inhibitor comprises a fatty acid compound or salt thereof selected from the group consisting of caprylic acid, palmic acid, lauric acid, myristic acid, palmitic acid, stearic acid, and combinations thereof, and alkali metal salts thereof; or
the corrosion inhibitor comprises an aromatic carboxylate corrosion inhibitor selected from sodium benzoate, sodium salicylate, and combinations thereof.

39. (canceled)

40. (canceled)

41. (canceled)

42. (canceled)

43. (canceled)

44. (canceled)
